(19) United States
(12) Patent Application Publication
(10) Pub. No.: US 2002/0118152 A1
(43) Pub. Date: Aug. 29, 2002

(54) Liquid crystal display

(75) Inventors: Kazuhiro Nukiyama, Kawasaki (JP); Takae Ito, Kawasaki (JP); Hiroshi Yamazaki, Kawasaki (JP); Yasutake Furukoshi, Kawasaki (JP)

Correspondence Address: Patrick G. Burns, Esq., GREER, BURNS & CRAIN, LTD., Suite 2500, 300 South Wacker Dr., Chicago, IL, 60606, US

(73) Assignee: FUJITSU LIMITED

(21) Appl. No.: 10/015,065

(22) Filed: Dec. 11, 2001

(30) Foreign Application Priority Data
Dec. 20, 2000 (JP) 2000-387892

(51) Int. Cl. G09G 3/36

(52) U.S. Cl. 345/87

(57) ABSTRACT

A data driving part takes in image display data in response to a clock signal supplied, and causes an image display part to display an image according to the image display data. A control part detects a change pattern of the image display data, and adjusts a phase relationship between the clock signal and image display data according to the detected change pattern.

### BACKGROUND OF THE INVENTION

1. Field of the Invention

The present invention relates to a liquid crystal display.

2. Description of the Related Art

Liquid crystal displays are recently used for monitors, such as those of personal computers (PC), and the monitors have been desired to be of large-sized, and of high-definition, with spread of PCs in recent years in the market. Accordingly, it is required that the liquid crystal displays which display images be of large-sized, and, also, various driving circuits therefor have higher performances.

FIG. 1 shows a configuration of a liquid crystal display in the related art. As shown in FIG. 1, the liquid crystal display includes a control circuit board 1 in which a timing controller 2 is provided, a gate driving part 3, a data driving part 5 including a data board 4 in which a liquid crystal driving circuits M1 through M10 are provided, and a display part 6. The gate driving part 3 and each of the liquid crystal driving circuits M1 through M10 are connected to the timing controller 2.

In the liquid crystal display which has the above configuration, image data is transmitted to the respective liquid crystal driving circuits M1 through M10 from the timing controller 2. Respective liquid crystal driving circuits M1 through M10 output the image data received, to the display part 6 which includes display pixels arranged in a form of matrix.

FIGS. 2A, 2B and 2C show waveforms for comparing delay amounts of the clock signal CLK supplied to the liquid crystal driving circuits M1 through M10 from the timing controller 2 shown in FIG. 1. Image data signal DATA is supplied to the respective liquid crystal driving circuits M1 through M10 from the timing controller 2, and the respective liquid crystal driving circuits M1 through M10 latch this image data signal DATA in timing of a rising edge at which the clock signal CLK changes from a low level (L) to a high level (H).

As shown in FIG. 2A, in the liquid crystal driving circuit M1 for which the wiring length from the timing controller 2 is shortest, this image data signal DATA is latched, for example, at a time T2. In this case, a setup time ST is a time interval from the time T1 to the time T2, and a hold time HT is a time interval from the time T2 to the time T3.

Since each of the other liquid crystal driving circuits M2 through M10 have the wiring lengths longer than the wiring length for the liquid crystal driving circuit M1 from the timing controller 2, the above-mentioned clock signal CLK is delayed by delay times Dl and D2 for the liquid crystal driving circuit M5 and the liquid crystal driving circuit M10, respectively, for example, as shown in FIGS. 2B and 2C. Accordingly, in the liquid crystal driving circuit M5, the image data signal DATA is latched at a time T4 delayed from the time T2 by a delay time D1, and, in the liquid crystal driving circuit M10, the image data signal DATA is latched at a time T5 delayed from a time T2 by a delay time D2.

(The reason why the clock signal CLK is delayed with respect to the data signal DATA will now be described. As the clock signal has the frequency more than twice the frequency of the data signal, a provision is made such that a driving performance for the clock signal becomes twice that for the data signal, or the like. Furthermore, the wiring for the clock signal is guarded by the ground for the purpose of coping with EMI problem, and, thereby, the wiring capacity thereof tends to become enlarged.)

Thus, as the wiring length is longer from the timing controller 2, the setup time is elongated while the hold time is shortened for the image data for the liquid crystal driving circuits. Thereby, the predetermined setup time and hold time may not be obtained, and, thus, timing errors therefrom may occur.

Especially, for a liquid crystal display which displays an image on a liquid crystal panel using thin-film transistors (TFT), since the frequencies of the image data signal DATA and clock signal CLK supplied to the driver included in the liquid crystal driving circuits M1 through M10 are the highest ones, there is difficulty in timing control of both signals precisely. Moreover, the waveforms of both the above-mentioned signals may become blunt greatly depending on the balance of the impedance determined according to the wiring lengths from the timing controller 2 and the driving performance of the timing controller 2, and, also, a difference may occur between both the signals in transmission time.

In such a situation, even if the timing of the image data signal DATA and the clock signal CLK outputted from the timing controller 2 is suitable, there is a case where one of the setup time ST and the hold time HT may become insufficient as mentioned above.

Timing adjustment is performed by adjusting delay of the clock signal CK or the data signal inside of the controller, and/or inserting buffers, dumping resistors, beads, pull-up resistors, pull down resistors, etc. in a transmission line, as disclosed by Japanese Laid-Open Patent Application No. 7-311561.

However, for respective drivers arranged at different positions as mentioned above, the impedance of the transmission path differs greatly due to the difference of the wiring length from the timing controller, and, since the influence of reflection also becomes large, there may be a problem that the above-mentioned timing adjustment is difficult.

Moreover, liquid crystal displays have been demanded to have large-sized screens and high definitions in recent years. For this reason, required data transmission rate increases due to the increase in display performance, and, also, the wiring length of each data line becomes longer so as to drive the large-sized screen. Accordingly, as the impedance increases due to the long transmission line, a time required for the signal transmitted changing between predetermined low level and high level becomes longer, and, also, as the data transmission rate increases, it may become difficult that the signal transmitted reaches the low level or high level sufficiently within the single clock period.

Furthermore, in case operation by a wide frequency band, such as 60 Hz and 75 Hz, as a refresh rate (frame frequency) of liquid crystal is guaranteed (i.e., when operation must be guaranteed by the frequency band wide for the clock frequency) according to the interface requirement, the amplitude of the clock signal and/or each image data signal should be changed according to the frequency of the clock signal.

Then, as shown in FIG. 3, (a), in case the image data signal DATA has an amplitude so small as to fall within the range between the ground voltage GND and power-supply voltage Vcc, for a pattern \mathring{1} which changes in data for each clock period, since the level of data changes quickly compared with a pattern \mathring{2} which changes in data after the same data continues for several clock periods, there is a problem that the hold time HT becomes shorter for the pattern \mathring{1}.

Specifically, since the hold time HT1 for the image data signal DATA in pattern \mathring{1} extends from the time T1 to the time T2 assuming that the hold time for the low level (L) is a time interval after the clock signal CLK reaches 70% of the full amplitude until the image data signal DATA reaches 30% of the full amplitude, this hold time HT1 is shorter than the hold time HT2 for the image data signal DATA in pattern \mathring{2} extending from the time T1 to the time T3.

Moreover, when the amplitude of the image data signal DATA exceeds the high level (H) of the power-supply voltage and/or exceeds the low level (L) of the ground voltage as in the pattern \mathring{2}, as shown in FIG. 3, (a), the setup time ST2 is shorter for the pattern \mathring{2} which changes in data after the same data continues for several clock periods than the pattern \mathring{1} which changes in data for each clock period.

Specifically, assuming that the setup time for the high level (H) denotes a time interval extending after the image data signal DATA reaches 70% of the full amplitude until the clock signal CLK reaches 70% of the full amplitude, the setup time ST2 for the image data signal DATA in pattern \mathring{2} is shorter than the setup time ST1 for the image data signal DATA in pattern \mathring{1}.

Moreover, for liquid crystal displays in recent years, optimization of tone-to-luminance characteristic is demanded so as to attain high-definition display performance. As shown in FIG. 4, an internal circuit configuration of a liquid crystal driver in the related art included in each of the liquid crystal driving circuits M1 through M10 has an external reference voltages V1 through V10 input thereto externally, and creates a reference tone voltages V1D through V16D for respective required tone levels through division resistors provided inside the driver. Then, a D-A converter 7 determines a driving voltage by performing D-A conversion on the latched image data signal by using the thus-obtained reference tone voltages, and, outputs a desired driving voltage after buffering it through an output amplifier 8.

In this configuration, the number of reference voltages created inside the driver increases due to increase in the number of display tone levels. In case the division-resistor ratios inside of the driver match the tone-to-luminance characteristic of the liquid crystal panel, it is not necessary to use any reference voltage input thereto externally. However, in fact, there is no complete agreement in division-resistance ratios among respective manufactures for the drivers, and the tone-to-luminance characteristic differs according to the characteristic of a particular liquid crystal panel. Accordingly, a method of using the tone reference voltages V1 through V10 input externally and thereby making a correction on the division-resistor ratios according to the particular characteristic is employed in common.

Moreover, it is necessary that the number of reference voltage levels be increased according to increase of the number of tone levels as mentioned above, and, thereby, the increased number of correction voltages should be input externally for the purpose of performing fine correction of the tone levels. Accordingly, the number of input terminals of the driver increases due to increase of the number of external inputs of the correction reference voltages, and, thereby, may exceeds the predetermined number, and, thus, it may be necessary to enlarge the package (TAB, etc.) of the driver.

However, since the number of display data signals increases in recent years due to the increase in the number of display tone levels, it becomes difficult to further increase the number of input terminals. In order to solve this problem, nodes corresponding to intermediate tone levels are left in open states, and, thus, are not drawn out from the driver internal circuit 10. However, in such a configuration, since tone levels to be corrected in case the liquid-crystal characteristic changes are not drawn out, it may not be possible to perform optimization sufficiently. If so, tone-to-luminance characteristic may be degraded, and/or the display quality may be degraded.

In recent years, furthermore, liquid crystal displays are demanded to be reduced in size of driving circuits located outside of the display area, as they have been made to have high-definition performance, reduced in frame size, and also, reduced in thickness. FIG. 5 shows a configuration of the data driving part 5 included in the liquid crystal display in the related art, and FIG. 6 is a timing chart which shows operation of the data driving part 5 shown in FIG. 5. As shown in FIG. 5, the data driving part includes a first data driver M1d, a second data driver M2d, a third data driver M3d, . . . , and a tenth data driver M10d, which are included in the liquid crystal driving circuits M1 through M10, respectively.

Moreover, in the liquid crystal display in the related art, the timing controller 2 takes in display data (FIG. 6, (b)) supplied by a personal computer (PC) body. Then, the first data driver M1d is provided with an effective data beginning signal (FIG. 6, (c)) by the timing controller 2 needed for driving the data driver. Further, the timing controller 2 provides to the respective data drivers MD1 through MD10 a clock signal CLK (FIG. 6, (a)) for taking in the input data, a latch signal LP (FIG. 6(d)) for outputting to the liquid crystal panel the data written in the data driver, an alternative-current driving signal POL (FIG. 6(e)) of writing voltage, and a reference supply voltage, together with the data signal.

Thus, it is necessary to provide to the drivers the signals for the driver control to perform display of a predetermined image on the liquid crystal panel, other than the image display data supplied from the PC body. For this purpose, the timing controller, even of a small-sized one, is needed for this purpose. Accordingly, there is a problem that it is difficult to reduce the scale of an integrated circuit in which the liquid crystal display is provided.

### SUMMARY OF THE INVENTION

The present invention has been devised for the purpose of solving the above-mentioned problems, and, an object of the present invention is to provide a liquid crystal display for which the cost and circuit scale can be effectively reduced while images having high quality can be displayed thereby.

A liquid crystal display according to the present invention includes:

a data driving part taking in image display data in response to a clock signal supplied, and causing an image display part to display an image according to the image display data; and

a control part detecting a change pattern of the image display data, and adjusting a phase relationship between the clock signal and image display data according to the detected change pattern.

Thereby, it is possible to effectively prevent an error in taking-in timing of image display data otherwise occurring due to the change pattern of the image display data.

The control part may use the image display data for three clock periods of the clock signal for detecting the change pattern of the image display data.

The control part may delay the image display data having logical levels changing for each clock period of the clock signal.

The control part may delay the clock signal.

The control part may detect the frequency of the clock signal, and adjusts the phase relationship between the clock signal and image data signal according to the detected frequency as well as the detected change pattern.

Thereby, as the phase relationship between both signals is adjusted according to the detected frequency as well as the detected change pattern, it is possible to make both signals have a predetermined phase relationship more precisely.

A liquid crystal display according to another aspect of the present invention includes:

a data driving part having a plurality of tone-level nodes having tone-level voltages generated depending on supplied reference voltages, and causing a liquid-crystal display part to display an image according to the tone-level voltages; and

a selecting part selecting from the plurality of tone-level nodes to which the reference voltages are supplied according to a given first control signal.

Thereby, through the selecting part, the destinations to which the reference voltages are applied can be changed, and, thus, the tone-level voltages can be easily adjusted.

The selecting part may be built inside of the data driving part, and the reference voltages may be provided from the outside of the data driving part.

The data driving part may take in a data signal transferred thereto according to a given second control signal, as the reference voltage.

Thereby, it is possible to improve flexibility of tone-level voltages (into a wider range) to be provided.

A liquid crystal display according to another aspect of the present invention includes:

a plurality of data driving parts causing a liquid-crystal display part to display an image according to image display data supplied in synchronization with a clock signal;

a control part supplying the image data signal and clock signal to the plurality of data driving parts; and

a timing correcting part provided in each of the plurality of data driving parts, and making the clock signal and image display data supplied by the control part have predetermined phase relationship therebetween.

Thereby, regardless of the disposed positions of the respective data driving parts, the clock signal and image display data can be made to have the predetermined phase relationship therebetween for each of the plurality of data driving parts.

The control part may detect signal transmission time periods required toward the data driving parts, generate a correction signal according to the detected data transmission time periods to be sent to the timing correcting part; and

the timing correcting part may make the clock signal and image display data have the predetermined phase relationship therebetween according to the supplied correction signal.

Thereby, it is possible to make the clock signal and image display data supplied to each of the data driving parts have the predetermined phase relationship therebetween precisely and also positively.

The control part may supply a monitoring data signal common for the timing correcting parts; and

each of the timing correcting parts may detect a phase difference between the thus-supplied monitoring data signal and the clock signal, so as to make the clock signal and image display data have the predetermined phase relationship therebetween.

Thereby, it is possible to make the clock signal and image display data supplied to each of the data driving parts have the predetermined phase relationship therebetween precisely and also positively.

A liquid crystal display according to another aspect of the present invention, includes:

a data driving part causing a liquid-crystal display part to display an image according to image display data by a given control signal; and

a control signal generating part built inside of the data driving part, and generating the control signal according to an external signal provided from the outside of the data driving part.

Thereby, it is possible to eliminate necessity of specially providing a circuit for generating the above-mentioned control signal.

The external signal may comprise a clock signal for determining timing by which the image data signal is taken in by the data driving part, and an effective display signal for determining a scope of the image display data to be actually used for image display performed by the liquid crystal display part.

The control signal may comprise a latch signal for storing the image display data into a latch circuit from which the image display data is supplied to the liquid-crystal display part.

The control signal may comprise an alternate-current driving signal for performing alternate-current control of a liquid crystal driving voltage to be supplied to the liquid-crystal display part.

The data driving part may use a voltage obtained through level shift of a voltage provided from the outside of the liquid crystal display, for driving the liquid-crystal display part, and cause the liquid-crystal display part to display an image according to the image display data.

A liquid crystal display according to another aspect of the present invention includes:

a liquid-crystal display part displaying an image; and

a data driving part taking in image display data sequentially according to an effective display signal used for determining a scope the image display data to be actually used for image display on the liquid-crystal display part, and causing the liquid-crystal display part to display an image according to the thus-taken-in scope of image display data.

Thereby, regardless of a control signal for determining taking-in timing for taking in image display data, the data driving part can take in the image display data in proper timing.

### BRIEF DESCRIPTION OF THE DRAWINGS

Other objects and further features of the present invention will become more apparent from the following detailed description when read in conjunction with the following accompanying drawings:

FIG. 1 shows a configuration of a liquid crystal display in the related art;

FIGS. 2A, 2B and 2C show waveforms for comparison of delay amounts of a clock signal supplied to a liquid crystal driving circuit from a timing controller shown in FIG. 1;

FIG. 3 shows waveforms illustrating latch operation for an image data signal in the liquid crystal display in the related art;

FIG. 4 shows a configuration of an internal circuit of a driver in the related art;

FIG. 5 shows a configuration of a data driving part shown in FIG. 1:

FIG. 6 shows waveforms for illustrating operation of the data driving part shown in FIG. 5;

FIG. 7 shows a block diagram illustrating a configuration of a liquid crystal display in a first embodiment of the present invention;

FIG. 8 shows a block diagram illustrating a configuration of an internal circuit included in a controller shown in FIG. 7;

FIG. 9 shows a circuit diagram illustrating a configuration of a data type detection circuit shown in FIG. 8;

FIG. 10 shows a circuit diagram illustrating a configuration of a clock frequency detection circuit shown in FIG. 8.

FIG. 11 shows a circuit diagram illustrating a configuration of a delay mode selection circuit unit included in a delay mode selection circuit shown in FIG. 8;

FIG. 12 shows a circuit diagram illustrating a configuration of a delay selection circuit shown in FIG. 8;

FIG. 13 shows waveforms illustrating operation of the liquid crystal display in the first embodiment of the present invention;

FIGS. 14A and 14B illustrate operation of the liquid crystal display in the first embodiment of the present invention;

FIG. 15 shows a circuit diagram illustrating a configuration of an internal circuit of the driver in the first embodiment of the present invention;

FIGS. 16A and 16B illustrate effect of the internal circuit of the driver shown in FIG. 15;

FIG. 17 shows a circuit diagram illustrating a configuration of a data driving part including a data driver including the internal circuit of the driver shown in FIG. 15;

FIG. 18 shows a circuit diagram illustrating a configuration of an alternative configuration of the data driving part including the data driver including the internal circuit of the driver shown in FIG. 15:

FIG. 19 shows a circuit diagram illustrating a configuration of a controller shown in FIG. 7;

FIG. 20 shows waveforms for illustrating operation of the liquid crystal display which has the data driving part shown in FIG. 18;

FIG. 21 shows a circuit diagram illustrating a configuration of a liquid crystal display in a second embodiment of the present invention;

FIGS. 22A and 22B show waveforms illustrating operation of the liquid crystal display in the second embodiment of the present invention;

FIG. 23 shows a circuit diagram illustrating a configuration of a delay circuit included in the liquid crystal driving circuit shown in FIG. 21;

FIGS. 24A-24C show waveforms illustrating operation of the delay circuit shown in FIG. 23.

FIG. 25 shows a circuit diagram illustrating a configuration of a control circuit board and a liquid crystal driving circuit shown in FIG. 21;

FIG. 26 shows a circuit diagram illustrating a configuration of a delay control part shown in FIG. 25;

FIG. 27 shows waveforms illustrating operation of the liquid crystal display shown in FIG. 25;

FIG. 28 shows a circuit diagram illustrating an alternative configuration of the delay circuit included in the liquid crystal driving circuit in the second embodiment of the present invention;

FIGS. 29A, 29B and 29C show waveforms illustrating operation of the delay circuit shown in FIG. 28;

FIG. 30 shows a block diagram illustrating a configuration of a data driving part in a third embodiment of the present invention;

FIG. 31 shows waveforms illustrating each signal supplied to the data driving part shown in FIG. 30;

FIG. 32 shows waveforms illustrating a latch signal and an alternate-current driving signal generated in each data driver shown in FIG. 30;

FIG. 33 shows a circuit diagram illustrating a control signal generation circuit which generates the latch signal and alternate-current driving signal shown in FIG. 32; and

FIG. 34 shows a circuit diagram illustrating a configuration of the data driving part shown in FIG. 30.

### DETAILED DESCRIPTION OF THE PREFERRED EMBODIMENTS

Embodiments of the present invention will now be described with reference to drawings. The same reference numerals are given to the same parts/components through the embodiments.

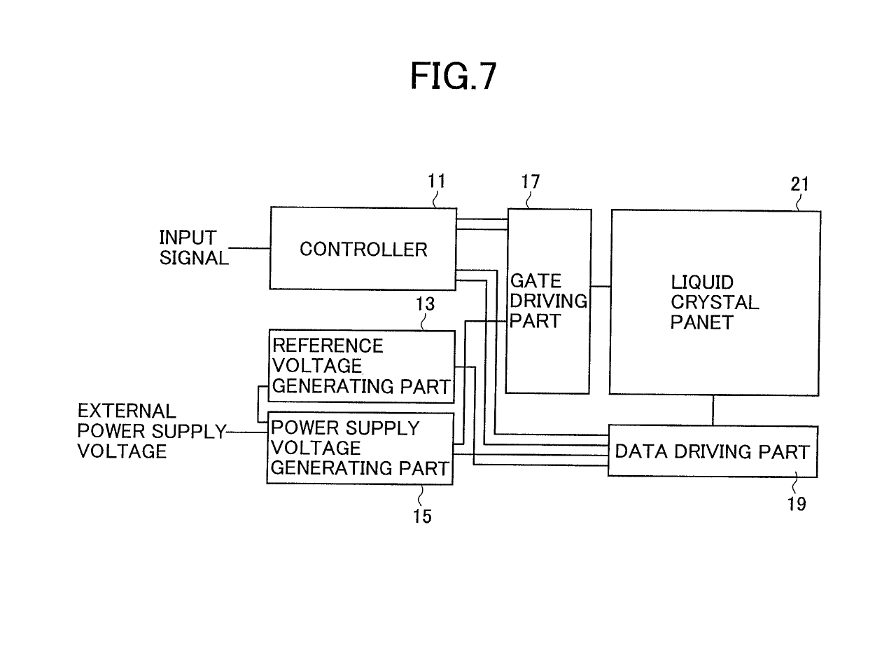

A first embodiment of the present invention will now be described. FIG. 7 is a block diagram showing a configuration of a liquid crystal display according to the first embodiment of the present invention. As shown in FIG. 7, the liquid crystal display in the first embodiment includes a controller 11, a reference voltage generating part 13, a power supply voltage generating part 15, a gate driving part 17, a data driving part 19, and a liquid crystal panel 21.

The controller 11 generates various control signals according to a given input signal, and supplies them to the gate driving part 17 and the data driving part 19. An external power supply voltage is supplied to the power supply voltage generating part 15. The power supply voltage generating part 15 is connected with the reference voltage generating part 13 which supplies a generated reference voltage to the data driving part 19 for driving the liquid crystal panel 21. The power supply voltage generating part 15 generates an internal power supply voltage according to the supplied external power supply voltage, and supplies the generated internal power supply voltage to the reference voltage generating part 13, the gate driving part 17, and the data driving part 19. The gate driving part 17 and the data driving part 19 operate so that images are displayed on the liquid crystal panel 21, in accordance with the control signal supplied from the controller 11.

The controller 11 includes a circuit for correcting the above-mentioned setup time and hold time according to a difference in level of the data signal (display data). Such a circuit will now be described in detail.

In order to correct the setup time and hold time, as an easier way, the data signal or the clock signal is delayed at an output part of the controller 11. A pattern needing correction to be made is detected from the data signal input into the controller 11. In this case, it is detected for data which changes in synchronization with the clock signal, as to which is larger, the number of signals for each of which the data changes for each clock period and the number of signals for each of which the data changes after the same data continues for several clock periods.

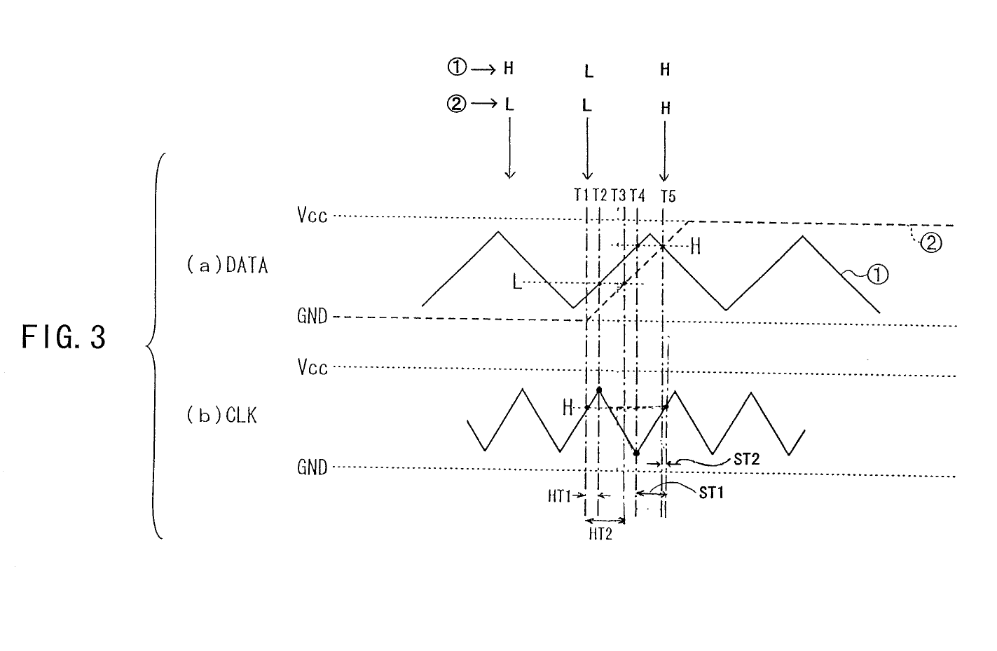

Specifically, a data signal for three clock periods is classified into a first pattern in which the data changes for each clock period as H-L-H or L-H-L in signal level, a second pattern in which the same data continues for two clock periods and then the data changes as H-H-L or L-L-H in signal level for each clock period, and a third pattern in which the data does not change according to the relevant clock signal as L-L-L, H-H-H, H-L-L or L-H-H. In the example of FIG. 3, the pattern \mathring{1} corresponds to H-L-H (first pattern) while the pattern \mathring{2} corresponds to L-L-H (second pattern), as shown in the figure. Then, as will now be described, the data signal or clock signal having the above-mentioned first pattern is delayed.

First, in a case where the data signal having the above-mentioned first pattern does not reach the predetermined high level (H) or does not reach the predetermined low level (L) so that the hold time becomes short (corresponding to the pattern \mathring{1} of FIG. 3, for example, and referred to as a case (a)), the hold time is corrected by carrying out predetermined time delay of this data signal.

On the other hand, in a case where the data signal having the first pattern exceeds the predetermined high level (H) or exceeds the predetermined low level (L) so that the setup time becomes short (case (b)), the data signal which has the above-mentioned second pattern and clock signal are delayed according to whether or not the number of the data signals each having the first pattern is equal to or later than the number of data signals each having the second pattern, and, thus, the setup time for the data signal having the first pattern is corrected. At this time, the amount of time delay of the data signal having the second pattern and that of the clock signal should be the same as one another.

Furthermore, when the frequency of the clock signal changes, the waveform of the data signal having the first pattern corresponds to the above-mentioned case (a) or case (b), or reaches H or L level exactly. Accordingly, the controller 11 determines whether the above-mentioned case (a) or case (b) occurs, or none of them occurs, according to which one of previously defined regions of frequency the detected frequency of the clock signal falls in. Then, according to the determination result, the controller 11 appropriately corrects the hold time and setup time as described above. A specific example thereof will now be described.

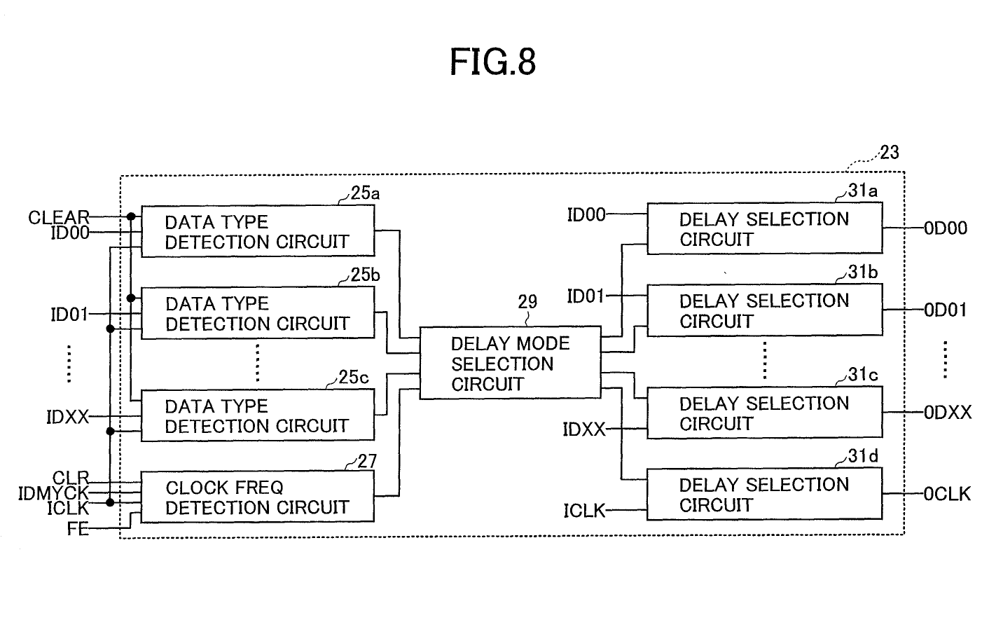

FIG. 8 is a block diagram showing a configuration of an internal circuit 23 of the controller 11 shown in FIG. 7. As shown in FIG. 8, the internal circuit 23 of the controller 11 includes data type detection circuits 25a through 25c, a clock frequency detection circuit 27, a delay mode selection circuit 29, and delay selection circuits 31a and 31d.

A signal CLEAR and respective data signals ID00 through IDXX are provided to the data type detection circuits 25a through 25c, and a clock signal ICLK is provided to the data type detection circuits 25a through 25c and the clock frequency detection circuit 27. The clock frequency detection circuit 27 is provided with a dummy clock signal IDMYCK, a signal CLR, and a signal FE.

The delay mode selection circuit 29 is connected to the data type detection circuits 25a through 25c and the clock frequency detection circuit 27, and the delay selection circuits 31a through 31d are connected to the delay mode selection circuit 29. The data signals ID00 through IDXX are provided to the delay selection circuits 31a through 31c, respectively, which then outputs corresponding data signals OD00 through ODXX. The clock signal ICLK is provided to the delay selection circuit 31d which then outputs a clock signal OCLK.

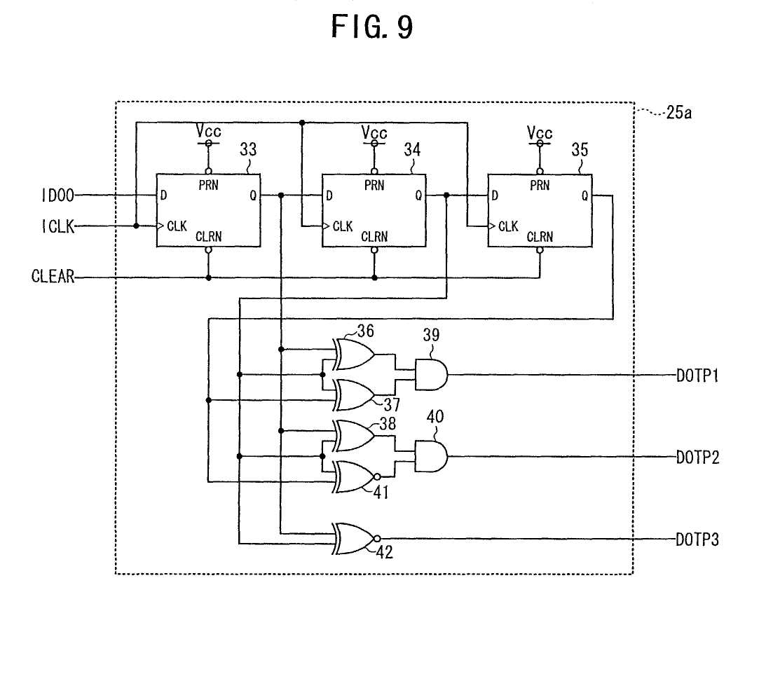

FIG. 9 is a circuit diagram showing a configuration of the above-mentioned data type detection circuit 25a shown in FIG. 8. Each of the data type detection circuits 25b through 25c shown in FIG. 8 has the same configuration as the data type detection circuit 25a shown in FIG. 9. As shown in FIG. 8, the data type detection circuit 25a includes delay flip-flops (DFF) 33 through 35, exclusive OR circuits 36 through 38, AND circuits 39 and 40 and exclusive NOR circuits 41 and 42.

The DFF 33 through 35 are connected in series, the data signal ID00 is supplied to the D terminal of the DFF 33, the clock signal ICLK is supplied to the CLK terminal thereof, and the signal CLEAR for performing a reset operation is supplied to the CLRN terminal. The output signal of the DFF 33 and the output signal of the DFF 34 are supplied to the exclusive OR circuit 36, and the output signal of the DFF 34 and the output signal of the DFF 35 are supplied to the exclusive OR circuit 37. The output signal of the DFF 33 and the output signal of the DFF 34 are supplied to the exclusive OR circuit 38, and the output signal of the DFF 34 and the output signal of the DFF 35 are supplied to the exclusive NOR circuit 41. The output signal of the DFF 33 and the output signal of the DFF 34 are supplied to the exclusive NOR circuit 42 which then outputs a data type detection signal DOTP3.

The AND circuit 39 is connected with the exclusive OR circuits 36 and 37, and outputs a data type detection signal DOTP1. The AND circuit 40 is connected with the exclusive OR circuit 38 and the exclusive NOR circuit 41 which outputs a data type detection signal DOTP2.

In the above-described data type detection circuit 25a, when the data signal ID00 supplied changes for each clock signal as H-L-H or L-H-L, the data type detection signal DOTP1 changes into its high level. When the data signal ID00 supplied maintains the same data and then changes as H-H-L or L-L-H, the data type detection signal DOTP2 changes into its high level. When the data signal ID00 supplied does not change, the data type detection signal DOTP3 changes into its high-level.

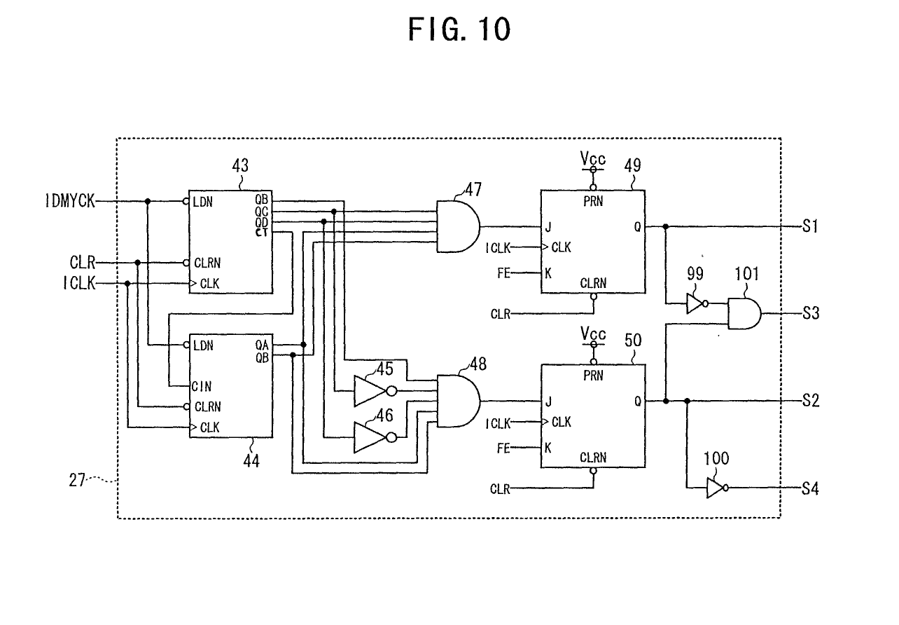

FIG. 10 is a circuit diagram showing a configuration of the clock frequency detection circuit 27 shown in FIG. 8. As shown in FIG. 10, the clock frequency detection circuit 27 includes counters 43 and 44, inversion circuits 45, 46, 99, and 100, AND circuits 47, 48, 101, and JK flip-flops (JKFF) 49 and 50.

The counters 43 and 44 are provided with a dummy clock signal IDMYCK at LDN terminals thereof, provided with a CLR signal at CLRN terminals for returning into the initial state for each frame, and provided with a clock signal ICLK at CLK terminals. The dummy clock signal IDMYCK is generated through oscillation at a frequency of 2 MHz, for example, by an oscillation circuit including resistors, capacitors, and a Schmidt trigger.

The CIN terminal of the counter 44 is connected to the CT terminal of the counter 43. The AND circuit 47 is connected to the QC terminal and the QD terminal of the counter 43, and to the QA terminal and the QB terminal of the counter 44. The inversion circuit 45 is connected to the QC terminal of the counter 43, and the inversion circuit 46 is connected to the QD terminal of the counter 43. The AND circuit 48 is connected to the QB terminal of the counter 43 and to the inversion circuit 45, and to the QA terminal and the QB terminal of the counter 44 and to the inversion circuit 46.

The JKFF 49 is connected to the AND circuit 47 at the J terminal, the clock signal ICLK is supplied to the CLK terminal thereof, the signal CLR is supplied to the CLRN terminal thereof, and a pulse signal FE which is activated for one clock period during a frame blanking interval is supplied to the K terminal thereof, and, a signal S1 is outputted therefrom at a Q terminal. Similarly, the J terminal of the JKFF 50 is connected to the AND circuit 48, the clock signal ICLK is supplied to the CLK terminal of the JKFF 50, the signal CLR is supplied to the CLRN terminal of the same, the signal FE is supplied to the K terminal thereof, the power supply voltage VCC is supplied to the PRN terminal thereof, and the JKFF50 outputs a signal S2 from the Q terminal.

The inversion circuit 99 is connected to the Q terminal of the JKFF 49, and the AND circuit 101 is connected to the inversion circuit 99 and the Q terminal of the JKFF 50. The AND circuit 101 outputs a signal S3. The inversion circuit 100 is connected to the Q terminal of the JKFF 50, and the inversion circuit 100 outputs a signal S4.

The counters 43 and 44 count the number of clock periods of the clock signal ICLK during the interval (for example, 1 microsecond) in which the supplied dummy clock signal IDMYCK has the high level.

Accordingly, the clock frequency detection circuit 27 determines whether the data signal ID00 through IDXX are of the above-mentioned case (a) in which the signals change for each clock signal but do not reach the high level or low level, or the case (b) in which the signals exceed the high level or low level. That is, when the frequency is high, the signal S1 is activated and it is determined as being of the case (a). When the frequency is low, the signal S4 is activated, and it is determined as being of the case (b). It is possible that, a signal for identifying the above-mentioned case (a) or case (b) directly to the delay mode selection circuit 29, without providing the clock frequency detection circuit 27 in the circuit 23 of the controller shown in FIG. 8. The determination result of the frequency is updated for every frame.

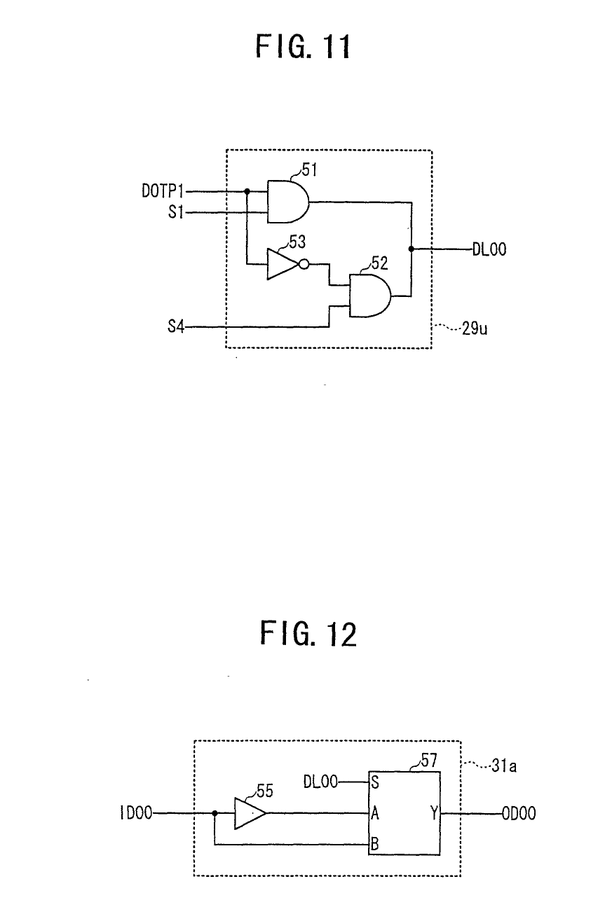

FIG. 11 is a circuit diagram showing a configuration of a delay mode selection circuit unit 29u included in the delay mode selection circuit 29 shown in FIG. 8. The delay mode selection circuit 29 shown in FIG. 8 includes three delay mode selection circuit units 29u which have the same configuration corresponding to respective data type detection signals DOTP1, DOTP2 and DOTP3 generated by the data type detection circuits 25a through 25c.

As shown in FIG. 11, the delay mode selection circuit unit 29u includes AND circuits 51 and 52 and an inversion circuit 53. The data type detection signal DOTP1 and the signal S1 are supplied to the AND circuit 51, and the data type detection signal DOTP1 is supplied to the inversion circuit 53. The AND circuit 52 is connected with the inversion circuit 53, and has the signal S4 input thereto.

The delay mode selection circuit 29 including these delay mode selection circuit units 29u each of which has the above-described configuration determines as to which data signal or clock signal is to be delayed according to the data pattern determined by the data type detection circuits 25a through 25c and the frequency determined by the clock frequency detection circuit 27, and thus, outputs a selection signal DL00.

FIG. 12 is a circuit diagram showing a configuration of the delay selection circuit 31a shown in FIG. 8. Each of the delay selection circuits 31b through 31d shown in FIG. 8 has the same configuration as that of the delay selection circuit 31a shown in FIG. 12.

As shown in FIG. 12, the delay selection circuit 31a includes a delay buffer 55 and a multiplexer 57. The data signal ID00 is supplied to the delay buffer 55, and an A terminal of multiplexer 57 is connected to the delay buffer 55. The multiplexer 57 has the selection signal DL00 input thereto from an S terminal, has the data signal ID00 input thereto from a B terminal, and outputs a signal ODOO from a Y terminal.

The delay selection circuit 31a which has the above-described configuration delays the data signal ID00 according to the selection signal DL00 generated by the delay mode selection circuit 29. The delay selection circuit 31d delays the clock signal ICLK according to the selection signal generated by the delay mode selection circuit 29, and outputs the clock signal OCLK.

Accordingly, the delay selection circuit 31a selects the signal to be delayed, according to the clock frequency. Specifically, for example, the delay selection circuits 31a through 31d delay only data signals having the first pattern when the clock frequency is 60 MHz or higher, delays the data signals which have patterns other than the first pattern and clock signals when the clock frequency is less than 50 MHz, and does not delay any signals as determining to be the suitable frequency when the clock frequency falls within a range between 50 and 60 MHz.

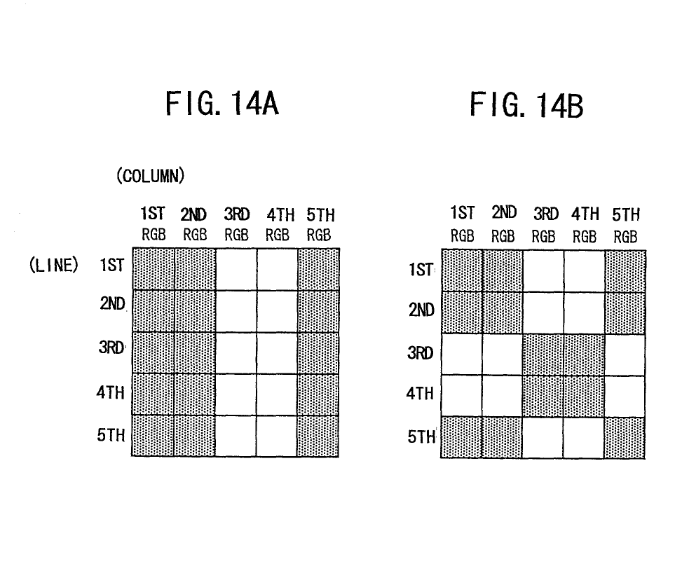

Description will now be made more specifically for examples in which the frequency of the clock signal input into is 54 MHz, 67.5 MHz and 43 MHz. FIGS. 14A and 14B show examples of types of data which have patterns in each of which a logic level changes for every clock period. FIG. 14A shows a 2-pixel vertical-stripe pattern, and FIG. 14B shows a 2-pixel checkered pattern.

Assuming that the data is adjusted so that the top and bottom of the amplitude thereof just reach the H level (power supply voltage level) and the L level (ground voltage level), respectively, in the condition where the clock frequency is 54 MHz. In this case, when the clock frequency is 67.5 MHz, the top and bottom of the amplitude cannot reach the power supply voltage level and the ground voltage level, respectively, and, thus, the above-mentioned case (a) occurs.

Assuming that the dummy clock signal IDMYCK having the frequency of 2 MHz and duty ratio of 50% is supplied to the clock frequency detection circuit 27 shown in FIG. 10, and the frequency of the clock signal ICLK is 54 MHz, the signal S1 has the low level and the signal S2 has the high level, and the signal S3 has the high level. Accordingly, both the data signal and the clock signal are not delayed, and are output as they are.

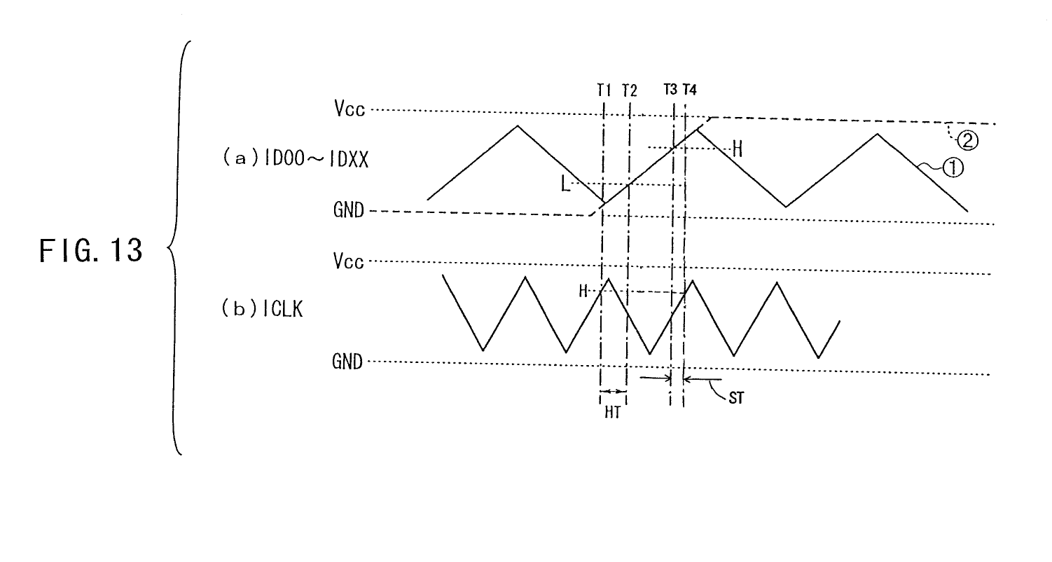

However, when the frequency of the clock signal input is 67 MHz, only the above-mentioned signal S1 has the high level. At this time, the delay selection circuit shown in FIG. 12 delays the data signal which has the first pattern in the data signal ID00 through IDXX, and attains the phase relationship between the data signal ID00 through IDXX, and the clock signal ICLK as that shown in FIG. 13. That is, in the phase relation shown in FIG. 13, the hold time HT for the low data extends from the time T1 to the time T2, and the setup time ST for the high data extends from the time T3 to the time T4. As can be seen from the figure, the hold time HT and setup time ST are made coincident between the pattern \mathring{1} in which data changes for each clock period and the pattern \mathring{2} in which the same data is retained for several clock periods and then changes.

Accordingly, the above-mentioned hold time HT and setup time ST can be made larger effectively than the hold time HT1 and the setup time ST2 of a case where the timing correction is not performed, as shown in FIG. 3.

When the clock frequency is 43 MHz, the above-mentioned signals S1 and S2 have the low level while the signal S4 has the high level. At this occasion, since this means that the above-mentioned case (b) occurs, the delay selection circuit shown in FIG. 12 delays the data signal not having the first pattern and clock signal by the same time period for the data signals ID00 through IDXX so that they are in phase with the data having the first pattern.

Thus, since the setup time and hold time can be made to have the optimum values by selectively delaying the clock signal and data signal according to difference in clock frequency, such as 54 MHz, 67.5 MHz, and 43 MHz, according to the liquid crystal display in the first embodiment of the present invention including the above-described circuits 23 of the controller, it is possible to positively obtain the data regardless of the clock frequency, and, thus, to attain image display with high quality.

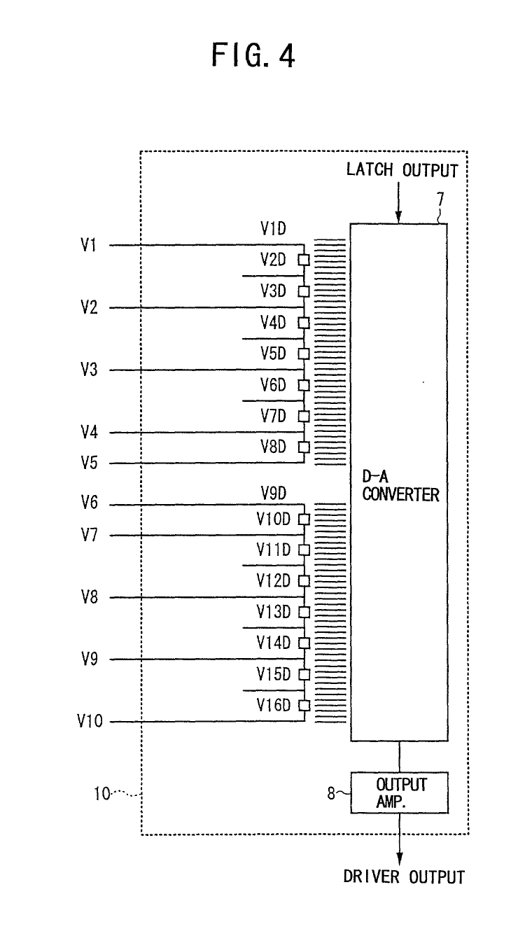

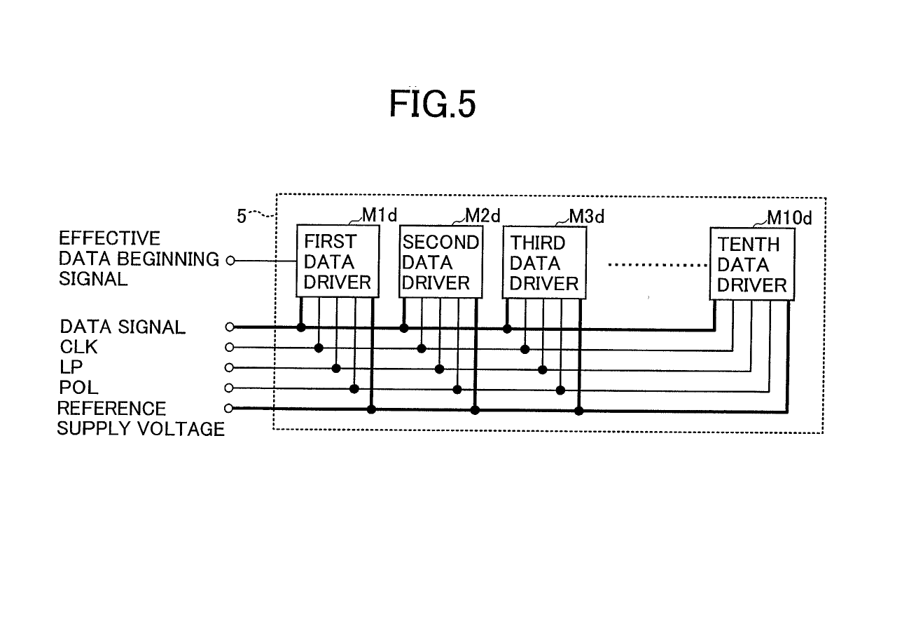

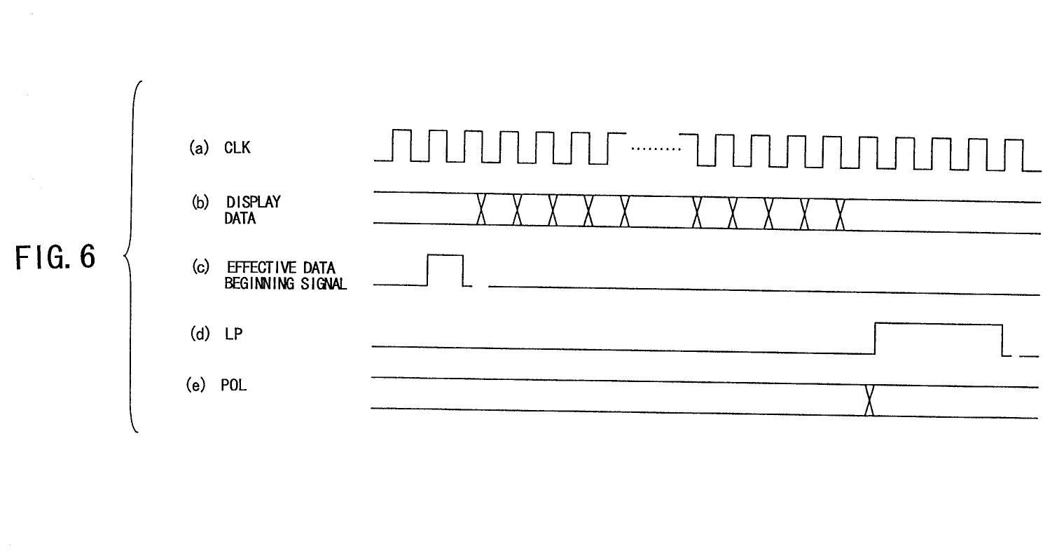

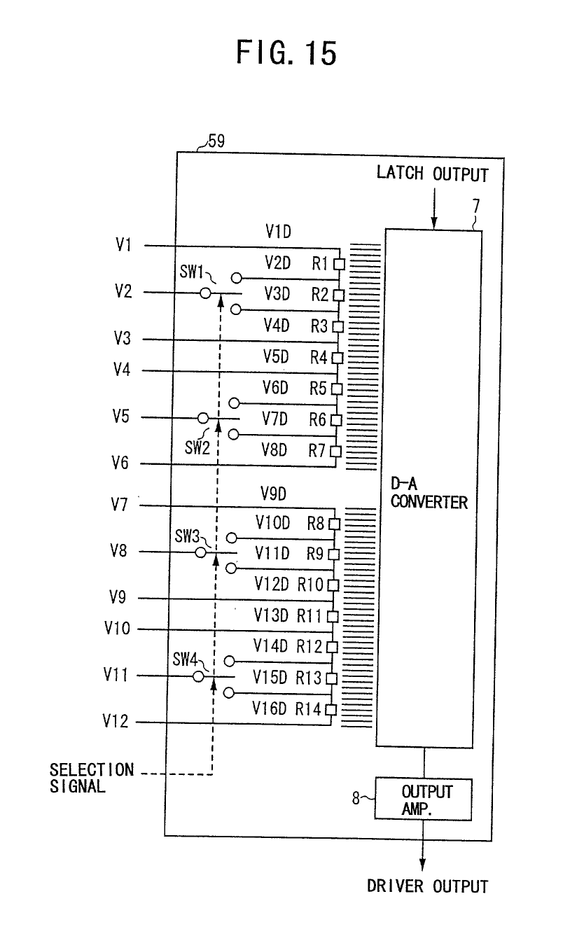

The data driving part 19 shown in FIG. 7 will now be described. FIG. 15 shows a configuration of an internal circuit 59 provided inside of a driver included in the data driving part 19. As shown in FIG. 15, although the internal circuit 59 of the driver in the first embodiment has a similar configuration as the internal circuit 10 of the driver shown in FIG. 4, a different therefrom is that analog switches SW1 through SW4 switched externally by selection signals are additionally provided.

For example, an external reference voltage V2 is supplied to a terminal of the switch SW1 on a first side, a first terminal thereof on a second side is connected to an intermediate node between a division resistor R1 and a division resistor R2, and a second terminal thereof on the second side is connected to an intermediate node between the division resistor R2 and a division resistor R3. Accordingly, according to the selection signal, the external reference voltage V2 is supplied to an appropriate one of the above-mentioned first terminal on the second side and the second end on the second side.

An external reference voltage V5 is supplied to a terminal of the switch SW2 on a first side, a first terminal on a second side thereof is connected to an intermediate node between a division resistor R5 and a division resistor R6, and a second terminal on the second side thereof is connected to an intermediate node between the division resistor R6 and a division resistor R7.

Similarly, an external reference voltage V8 is supplied to a terminal of the switch SW3 on a first end, a first terminal on a second side thereof is connected to an intermediate node between a division resistor R8 and a division resistor R9, and a second terminal on the second side thereof is connected to an intermediate node between the division resistor R9 and a division resistor R10.

Further, an external reference voltage V11 is supplied to a terminal of the switch SW4 on a first side, a first terminal thereof on a second side is connected to an intermediate node between a division resistor R12 and a division resistor R13, and a second terminal thereof on the second side is connected to an intermediate node between the division resistor R13 and a division resistor R14.

Operation of the above-mentioned switches SW1 through SW4 is made according to the following Table 1:

TABLE 1

| Selection | | | | |
|---|---|---|---|---|
| Signal | SW1 | SW2 | SW3 | SW4 |
| | V2 | V5 | V8 | V11 |
| H | V2D | V6D | V10D | V14D |
| L | V3D | V7D | V11D | V16D |

That is, as shown in the above-mentioned Table 1, for example, the switch SW1 supplies the external voltage V2 to the node for a reference tone-level voltage V2D when the high-level (H) selection signal is supplied thereto. The switch SW1 supplies the external voltage V2 to the node for a reference tone-level voltage V3D when the low-level (L) selection signal is supplied thereto.

In addition, the external reference voltages V1 through V12 shown in FIG. 15 are supplied externally for the purpose of correcting the reference tone-level voltages, and, according to these externally supplied voltages and division resistors R1 through R14, the actual reference tone-level voltages V1D through V16D are generated. Moreover, by subdividing the division resistors R1 through R14 into finer resistor portions for a required number of tone levels, the number of reference voltages according to the number of tone-level levels are generated thereby, and are provided to the D-A converter 7 to be used for D-A conversion performed there.

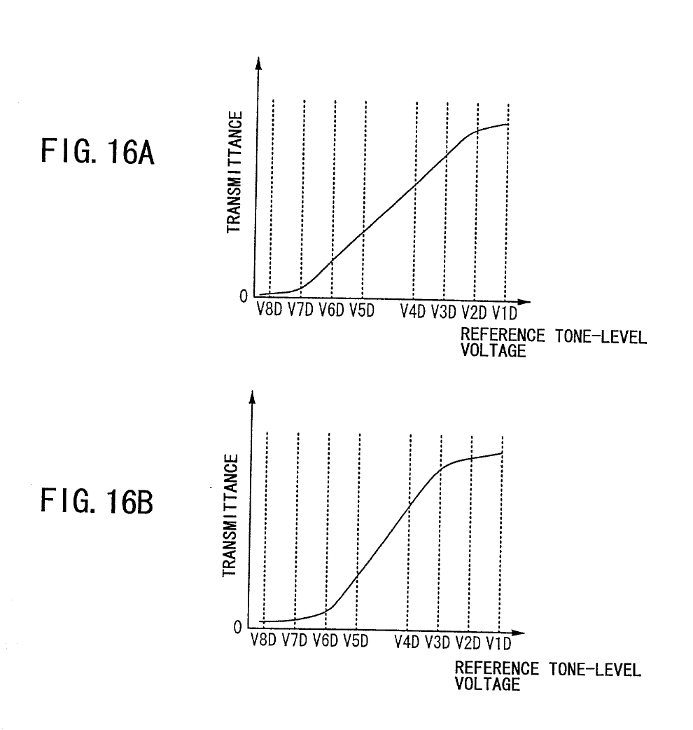

FIG. 16 illustrates effect of operation performed by the internal circuit 59 of the driver shown in FIG. 15, and shows the characteristics of the liquid crystal panel, i.e., relationship of transmittance thereof with respect to the voltage applied thereto. The characteristic of FIG. 16A differs from that of FIG. 16B. The characteristic shown in FIG. 16A has non-linear portions around the reference tone-level voltages of V2D and the V7D, respectively. In such a case, the reference tone-level voltages V2D and V7D should be corrected. Similarly, in the case of FIG. 16B, as non-linear portions are present around the reference tone-level voltages V3D and the V6D, respectively, these reference tone-level voltages should be adjusted.

Therefore, according to the first embodiment of the present invention, by changing the reference tone-level voltages appropriately depending on variation of the characteristic of the liquid crystal panel 21, the internal circuit 59 of the driver can supply the tone-level voltages for the optimum intermediate-tone levels to the D-A converter 7.

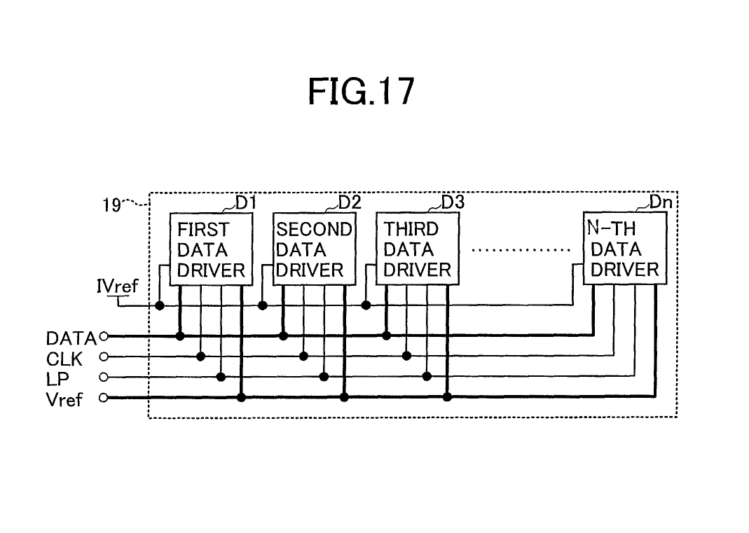

FIG. 17 is a block diagram showing a configuration of a data driving part 19 including a data driver including the internal circuit 59 shown in FIG. 15. As shown in FIG. 17, the data driving part 19 includes n data drivers, i.e., a first one Dl through n-th one Dn, and, to each data driver, the data signal DATA, clock signal CLK, voltages Vref of external reference voltages V1 through V12, and a selection signal IVref are provided. By changing a logic level of the selection signal IVref externally, switches SW1 through SW4 are controlled as described above, and tone levels in the data driver are thus selected.

The above-mentioned data signal DATA, clock signal CLK, latch signal LP and the selection signal IVref are generated by the controller 11, and the voltages Vref including the external reference voltages V1 through V12 are generated by the reference voltage generating part 13.

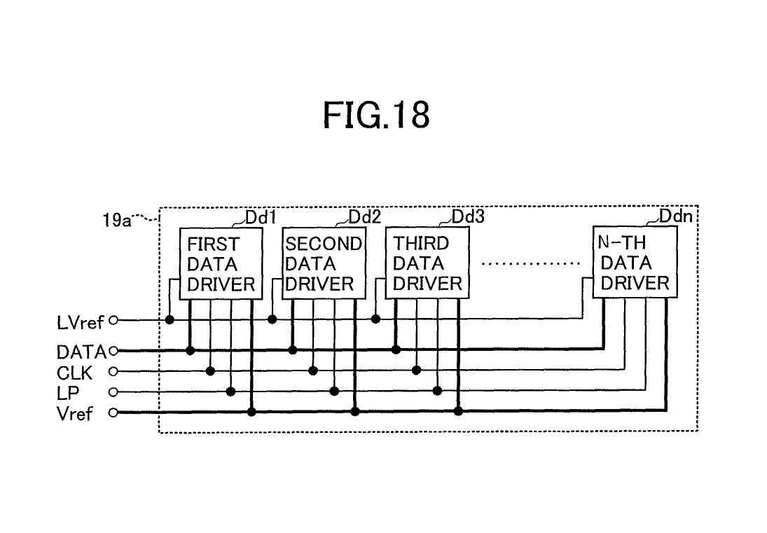

Instead of the above-mentioned data driving part 19, a data driving part 19a shown in FIG. 18 may be employed. The data driving part 19a includes n data drivers, i.e., a first data driver Dd1 through an n-th data driver Ddn, and a signal LVref is further supplied to each data driver from the controller 11. Further, each data driver takes in selection data from the data signal DATA when the supplied signal LVref has a high level, and, by using the selection data as the above-mentioned voltages Vref, even complicated control of tone levels for desired image characteristics can be attained. Such a control operation may be performed during display operation.

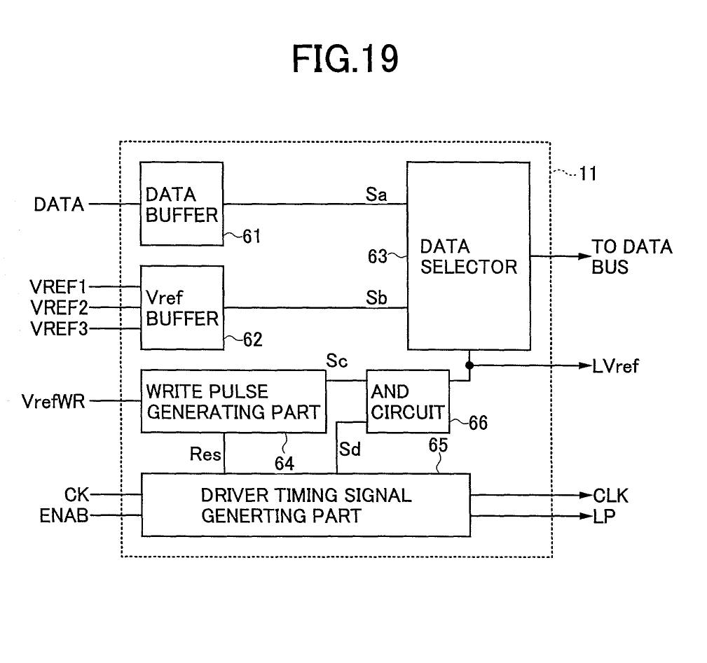

FIG. 19 shows a configuration of the controller 11 shown in FIG. 7. The controller 11 includes a data buffer 61, a Vref buffer 62, a data selector 63, a write pulse generating part 64, a driver timing signal generating part 65, and an AND circuit 66, as shown in FIG. 19. The data selector 63 is connected to the data buffer 61, Vref buffer 62, and AND circuit 66, and the AND circuit 66 is connected to the write pulse generating part 64 and driver timing signal generating part 65. The driver timing signal generating part 65 is connected to the write pulse generating part 64.

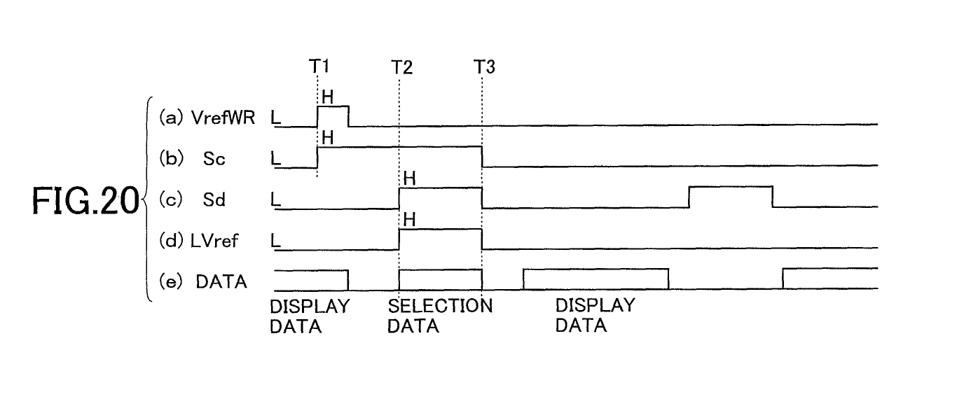

Operation of the above-described controller 11 will now be described with reference to a timing chart shown in FIG. 20. First, when a signal VrefWR supplied to the write pulse generating part 64 at a time T1 is activated as shown in FIG. 20, (a), the write pulse generating part 64 starts outputting a high-level signal Sc at the time T1, as shown in FIG. 20, (b). The signal Sc is changed to have a low level at a time T3 at which a retrace interval for data displayed on the liquid crystal panel 21 finishes and a signal Res is supplied from the driver timing signal generating part 65.

The driver timing signal generating part 65 supplies a signal Sd which indicates the retrace interval shown in FIG. 20, (c), to the AND circuit 66. Thereby, as shown in FIG. 20, (d), the high-level signal LVref is supplied to the data selector 63 from the AND circuit 66 between the time T2 and the time T3.

The data signal DATA is supplied to the data selector 63 as a signal Sa through the data buffer 61. The selection signals VREF1 through VREF3 for selecting the reference voltages are supplied to the data selector 63 as a signal Sb through the Vref buffer 62. The data selector 63 is controlled by the above-mentioned signal LVref supplied from the AND circuit 66, and, when the signal LVref has a low level, the signal Sa is selected, but, when it has a high level, the signal Sb is selected. The thus-selected data is output to the data bus.

Accordingly, the data selector 63 supplies the selection data shown in FIG. 20, (e) from the time T2 when the signal LVref has the high level to the time T3, to the data bus. Thereby, as described above, each data driver shown in FIG. 18 takes in this selection data in response to the supplied high-level signal LVref.

Thus, according to the liquid crystal display in the first embodiment, since the tone-to-luminance characteristic of a display image can be switched or adjusted easily, the optimum internal tone levels according to the characteristic of the liquid crystal panel 21 can be realized even through inputting of a reduced number of the correction reference voltages, and thus, a high-quality image can be displayed.

A second embodiment of the present invention will now be described.

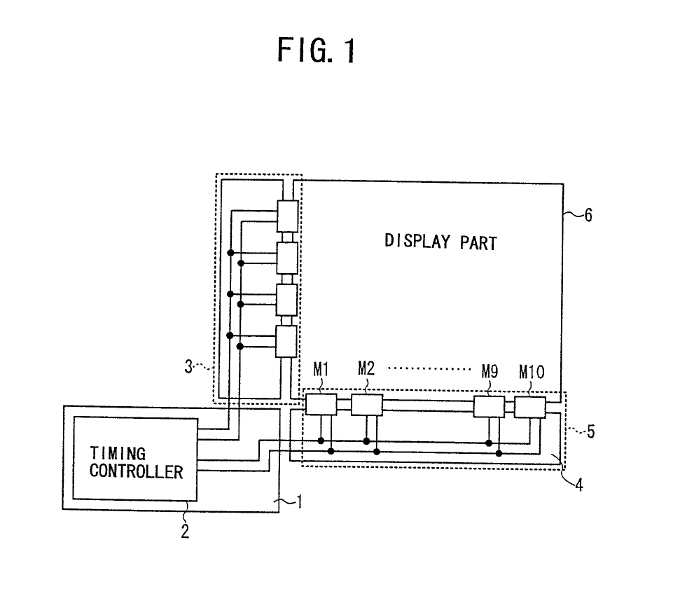

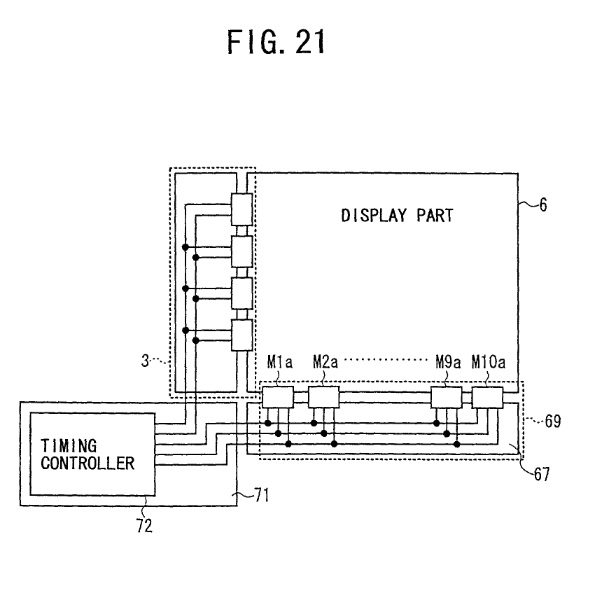

FIG. 21 shows a configuration of a liquid crystal display in the second embodiment of the present invention. As shown in FIG. 21, although the liquid crystal display in the second embodiment has a similar configuration as the liquid crystal display in the related art shown in FIG. 1, it is different in that a control circuit board 71 has a timing controller 72 provided therein, and a data board 67 has liquid crystal driving circuits M1a through M10a provided therein.

The liquid crystal display in the second embodiment includes the liquid crystal driving circuits M1a through M10a to which different delay times according to the disposed positions thereof are previously set in order to eliminate the timing error resulting from the delay produced when the clock signal is transmitted to the respective liquid crystal driving circuits M1a through M10a from the timing controller 72.

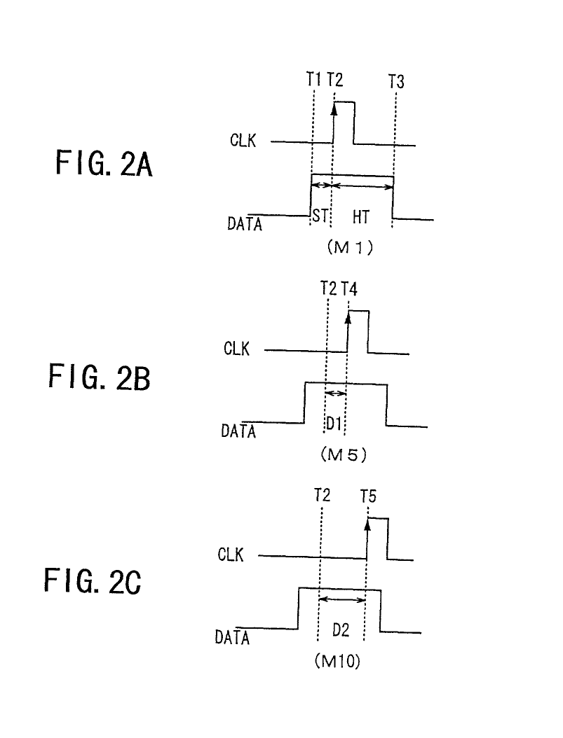

Namely, for example, the delay times are previously set so that, when the clock signal CLK and the data signal DATA have phase relationship as shown in FIG. 2B, the data signal DATA be delayed the time interval D1 in the liquid crystal driving circuit M5a, and when the phase relation is such as that shown in FIG. 2C, the data signal DATA be delayed the time interval D2 in the liquid crystal driving circuit M10a. Thereby, the setup time ST and the hold time HT in each of the liquid crystal driving circuits M5a and M10a can be made equal to those of the liquid crystal driving circuit M1a shown in FIG. 2A, and the data signal DATA can be latched at a same timing in each of the liquid crystal driving circuits M1a, M5a, and M10a.

For the respective liquid crystal driving circuits M1a through M10a, the delay times may be set on the data board 67 after they are disposed. Alternatively, it is also possible that, by receiving signals which indicate disposed positions thereof provided by the timing controller 72, the respective liquid crystal driving circuits M1a through M10a set or correct the above-mentioned delay times, respectively.

Further, it is also possible that data signals for monitoring (monitoring data signals) are supplied by the timing controller 72 to the respective liquid crystal driving circuits M1a through M10a, and, then, the respective liquid crystal driving circuits M1a through M10a correct the amounts of delay automatically by calculating the phase difference between the clock signals and thus-provided monitoring data signals.

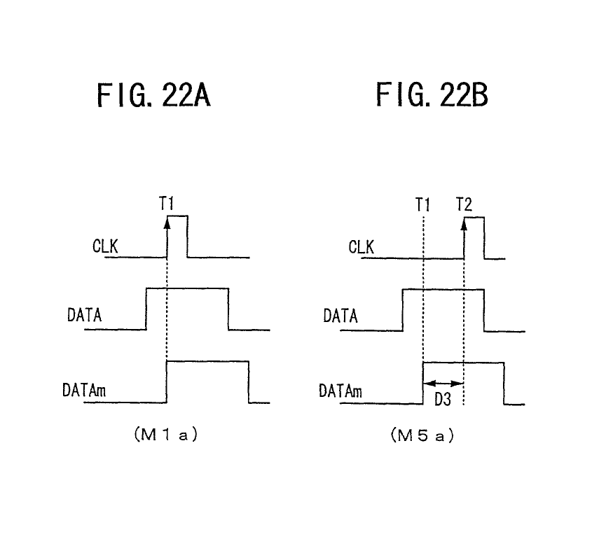

FIG. 22A shows a timing chart illustrating a case where in the liquid crystal driving circuit M1a, the above-mentioned data signal DATAm for monitoring is synchronized so that this signal rise up at a time T1 at which the clock signal CLK changes from the low level to the high level. FIG. 22B shows a timing chart illustrating phase relationship between the above-mentioned data signal DATAm for monitoring and clock signal CLK in the liquid crystal driving circuit M5a. As compared with the case of liquid crystal driving circuit M1a shown in the timing chart, the clocks signal CLK is delayed by a time interval D3 due to transmission, and, thereby, the rising timing becomes at a time T2. The above-mentioned data signal DATAm for monitoring is such as a pulse signal which has the high level once per each horizontal period.

Thus, as described above, the respective liquid crystal driving circuits M1a through M10a calculate the delay times of the clock signals, by comparing the timing of rising up between the data signal DATAm and clock signal CLK. Then, according to the thus-obtained delay times, they can correct the timing of taking in the data signals DATA.

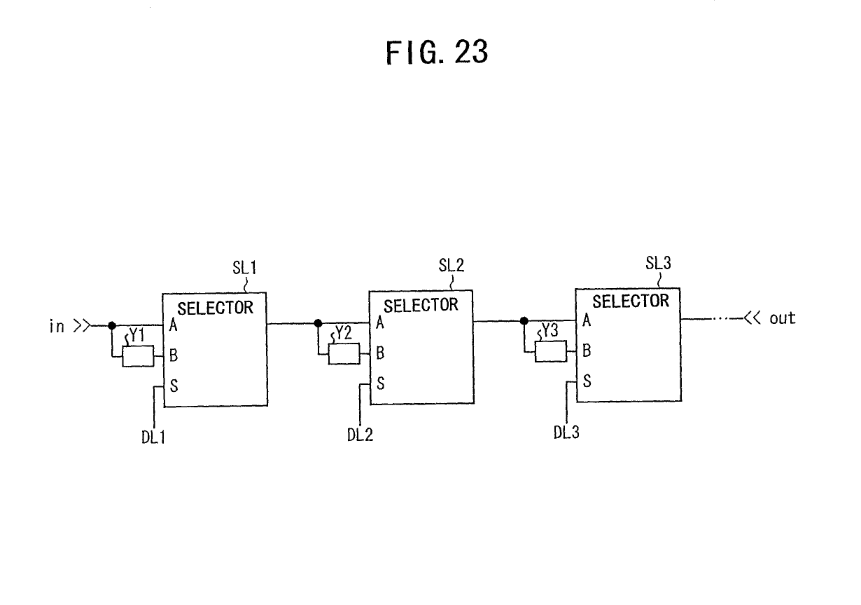

More specifically, description will now be made with reference to FIG. 23. FIG. 23 shows a configuration of a delay circuit included in each of the liquid crystal driving circuits M1a through M10a shown in FIG. 21. As shown in FIG. 23, the delay circuit includes selectors SL1 through SL3 and delay devices Y1 through Y3 connected in series. The delay devices Y1 through Y3 give delays to the signals input to A terminals, and provide the thus-delayed signals to B terminals. The delay device Y1 delays the input signal by 1 ns, the delay device Y2 delays the input signal by 2 ns, and the delay device Y3 delays the input signal by 4 ns, for example.

Delay time selection signals DL1 through DL3 are supplied to S terminals of the selectors SL1 through SL3, respectively. When these delay time selection signals DL1 through DL3 have a high level, the selectors SL1 through SL3 input the data signals from the B terminals, and when they have a low level, selectors SL1 through SL3 input the data signals from the A terminals.

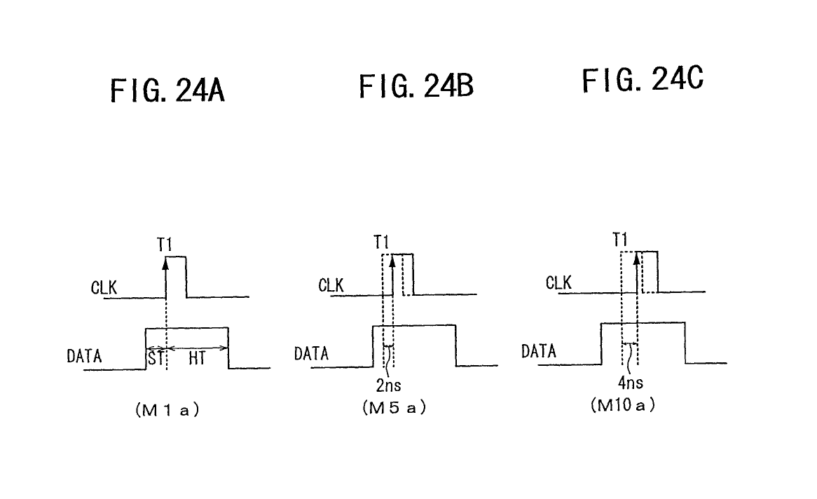

For example, as shown in FIGS. 24A through 24C, it is assumed that delay in the clock signal CLK occurs between the liquid crystal driving circuit M1a and the liquid crystal driving circuit M5a by 2 ns, while delay in the clock signal CLK occurs between the liquid crystal driving circuit M1a and the liquid crystal driving circuit M10a by 4 ns.

At this time, only the selector SL2 inputs the data signal from the B terminal, as a result of the delay time selection signals DL1 through DL3 having logic levels of (L, H, L), respectively, being provided to the above-mentioned delay circuit included in the liquid crystal driving circuit M5a. Accordingly, as described above, as the selector SL2 thus delays this data signal by 2 ns through the delay device Y2, the clock signal CLK and the data signal DATA thus have the phase relationship shown in FIG. 24A.

Similarly, only the selector SL3 inputs the data signal from the B terminal, as a result of the delay time selection signals DL1 through DL3 having logic levels of (L, L, H) being provided to the above-mentioned delay circuit included in the liquid crystal driving circuit M10a. Accordingly, as described above, as the selector SL3 thus delays this data signal by 4 ns through the delay device Y3, the clock signal CLK and the data signal DATA thus have the phase relationship shown in FIG. 24A.

The above-mentioned delay time selection signals DL1 through DL3 can be supplied to the delay circuits as a result of generation thereof performed by the timing controller 72 shown in FIG. 21, or selection setting being made on the data board 67.

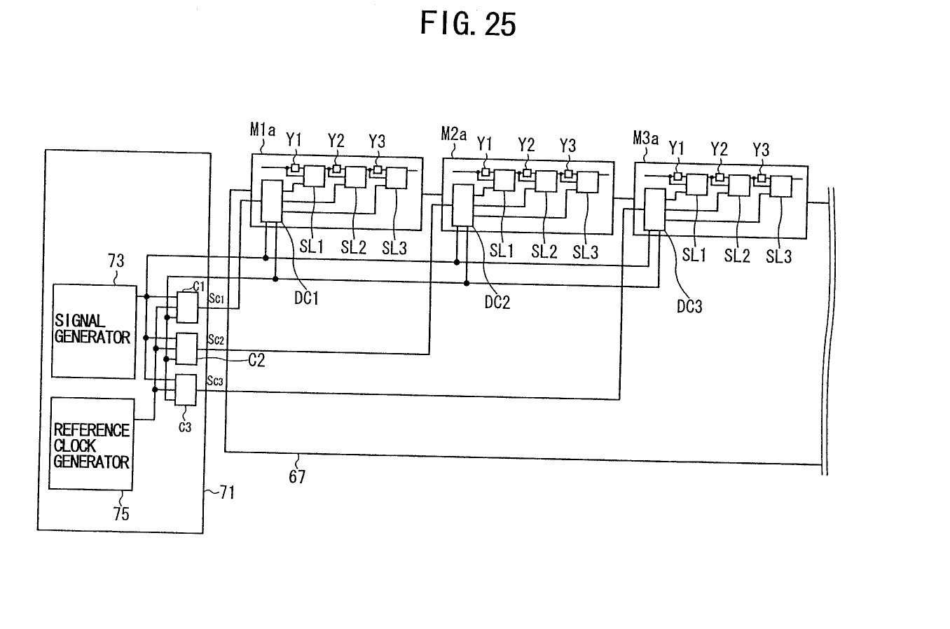

FIG. 25 shows a configuration of the control circuit board 71 and liquid crystal driving circuits M1a through M3a, shown in FIG. 21. As shown in FIG. 25, in the control circuit board 71, counters C1 through C3, a signal generator 73, and a reference clock generator 75 are provided. The signal generator 73 generates a pulse wave of the same frequency as the clock signal CLK, and the reference clock generator 75 generates a reference clock signal used for calculating a delay time. The number of the counters C1 through C3 is the same as the number of the liquid crystal driving circuits M1a through M3a, and each of the counters C1 through C3 are connected to the signal generator 73 and the reference clock generator 75.

As shown in FIG. 25, delay control parts DC1 through DC3 which control delay times, in addition to the above-mentioned delay circuit shown in FIG. 23, are provided in each of the liquid crystal driving circuits M1a through M3a, and each of the delay control parts DC1 through DC3 is connected to the signal generator 73 and counters C1 through C3 as well as the selectors SL1 through SL3.

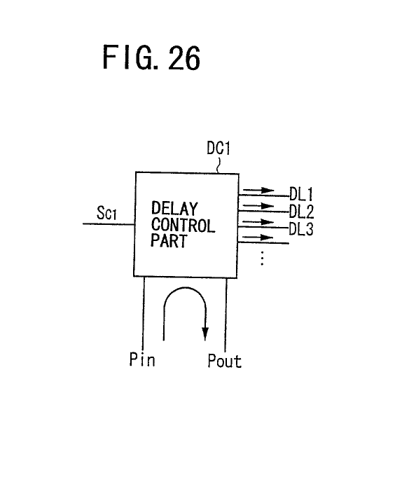

In the liquid crystal display which has the above-described configuration, the pulse wave generated by the signal generator 73 is transmitted to the delay control parts DC1 through DC3 included in each of the liquid crystal driving circuits M1a through M3a. Then, as shown in FIG. 26, each of the delay control parts DC1 through DC3 outputs the thus-provided pulse wave Pin to a respective one of the counters C1 through C3 as a pulse wave Pout as it is. Since transmission of these pulse waves Pout in such a manner is approximately the same phenomenon as reflection, it will be referred to as ‘reflection’, hereinafter.

Then, each of the counters C1 through C3 provided in the control circuit board 71 detects a first rising-up timing of the pulse wave Pout provided by the above-mentioned reflection, and, counts the number of pulses of the reference clock signal supplied from the reference clock generator 75 during an interval between this detection timing and the above-mentioned first rising-up timing of the pulse wave Pout generated by the signal generator 73. Then, the counters C1 through C3 transmit signals SC1 through SC3 to be used as the delay time selection signals DL1 through DL3, respectively, to the corresponding delay control parts DC1 through DC3 according to these count numbers (values), and each of the delay control parts DC1 through DC3 supplies the supplied signals SC1 through SC3 (delay time selection signals DL1 through DL3) to the selectors SL1 through SL3.

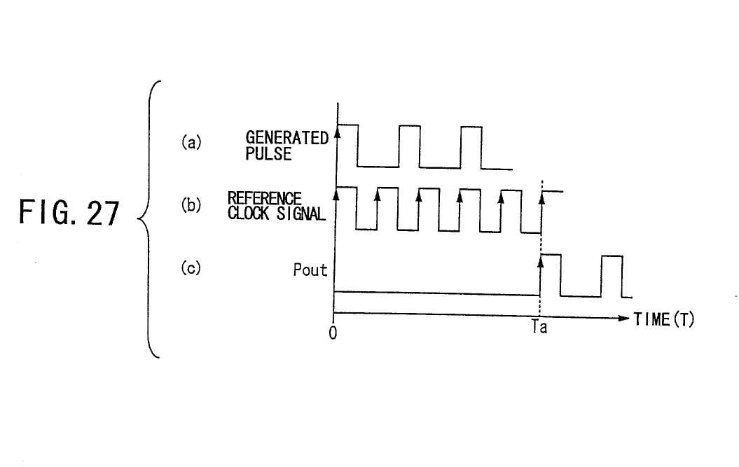

When, for example, generated pulses shown in FIG. 27, (a), are supplied from the signal generator 73 to the counter C1, reference clock pulses shown in FIG. 27, (b) are supplied from the reference clock generator 75, and, also, the pulse wave Pout shown in FIG. 27, (c) is supplied from the delay control part DC1, the counter C1 counts five times of rising up of pulses of the reference clock signal generated within the delay time Ta of the pulse wave Pout with respect to the generated pulses. Accordingly, at this case, the counter C1 generates the above-mentioned signal SC1 according to this number of counts, and the delay control part DC1 supplies the delay time selection signals DL1 through DL3 with logic levels (H, L, H) supplied as the signal SC1 to the selectors SL1 through SL3.

Similarly, it is also possible that, position information which indicates the disposed position of each of the liquid crystal driving circuits M1a through M10a is employed, instead of the above-mentioned signals SC1 through SC3, to be supplied to each of the delay control parts DC1 through DC3, and the delay control parts DC1 through DC3 generate the above-mentioned delay time selection signals DL1 through DL3 according to the thus-supplied position information, and supply them to the selectors SL1 through SL3.

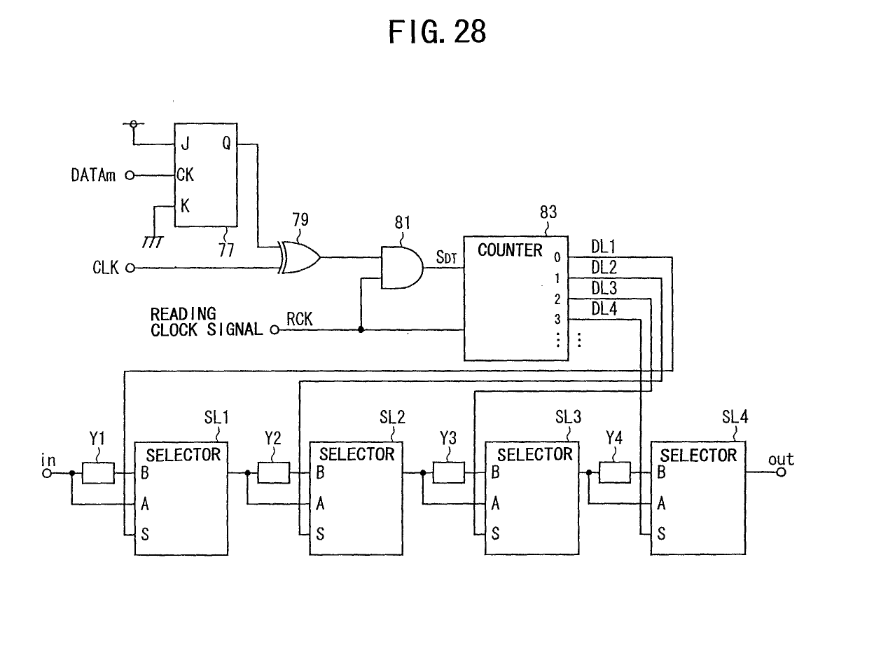

Moreover, it is also possible that each of the liquid crystal driving circuits M1a through M10a in the second embodiment according to the present invention includes a delay circuit shown in FIG. 28. That is, as shown in FIG. 28, the delay circuit includes four selectors SL1 through SL4 which have the same configuration, and delay devices Y1 through Y4, a JK flip-flop (JKFF) 77, an exclusive OR circuit 79, an AND circuits 81 and counters 83. The selectors SL1 through SL4 are connected in series, and each of the delay devices Y1 through Y4 delays the signal input into a B terminal thereof. An S terminal of each of the selectors SL1 through SL4 is connected to the output node of the counter 83. The delay device Y4 delays the inputted signal by 8 ns.

The data signal DATAm for monitoring is supplied to a CK terminal of the JKFF 77 from the timing controller 72. The clock signal CLK is supplied to a first input node of the exclusive OR circuit 79, and a second input node is connected to a Q terminal of the JKFF 77. While a reading clock signal is supplied to a first input node of the AND circuit 81, a second input node thereof is connected to the exclusive OR circuit 79. The reading clock signal RCK is made synchronized with the data signal DATAm for monitoring.

While this reading clock signal RCK is supplied to a first input node of the counter 83, a second input node thereof is connected to the output node of the AND circuit 81.

In the delay circuit which has the above-described configuration, the data signal DATAm for monitoring synchronized with the clock signal CLK is supplied to the CK terminal of the JKFF 77 in liquid crystal driving circuit M1a, a high-level power supply voltage is supplied to the J terminal thereof, and the grounding voltage having a low level is supplied to the K terminal thereof. Thereby, the signal having a high level only during the delay time of the clock signal CLK is outputted from the exclusive OR circuit 79 to which the signal outputted from the Q terminal and the clock signal CLK are input. Then, by calculating the logical product of this signal and the reading clock signal RCK, the AND circuit 81 generates a signal SDT deactivated into a low level when the clock signal CLK has the high level, and supplies it to the counter 83.

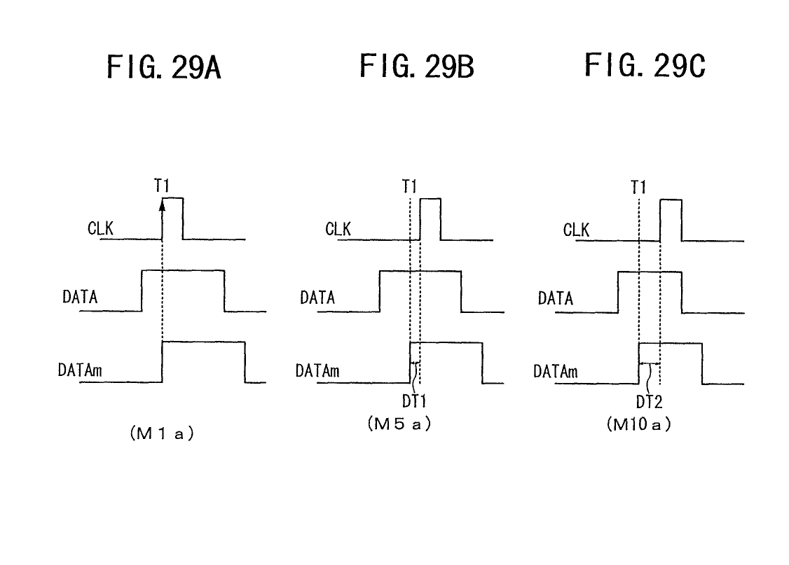

Thereby, the counter 83 counts the number of clock pulses of the reading clock signal RCK input during the interval in which the supplied signal SDT has the high level, generates delay time selection signals DL1 through DL4 according to the thus-counted number, similarly to the above-mentioned counters C1 through C3, and supplies them to the selector SL4 Accordingly, as shown in FIGS. 29A through 29C, the delay circuit shown in FIG. 28, in each of the liquid crystal driving circuits M5a and M10a, detects the delay time DT1 and DT2 of the clock signal CLK with respect to the data signal DATAm for monitoring, and, delays the data signal DATA according to this delay time DT1 and DT2, respectively. Thereby, the phase relationship between the clock signal CLK and the data signal DATA is controlled to be the same as that of the liquid crystal driving circuit M1a shown in FIG. 29 Thus, according to the second embodiment of the present invention, as the phase difference of the data signal DATA supplied to the liquid crystal driving circuit M1a through M10a disposed at different positions with respect to the clock signal CLK can be eliminated in each of the liquid crystal driving circuits M1a through M10a, the data signal DATA can thus be latched at the same timing, and desired setup time and desired hold time can be obtained there. Thereby, an image produced according to this data signal DATA can be positively displayed on the display part 6.

A third embodiment of the present invention will now be described. A liquid crystal display in the third embodiment of the present invention has the same configuration as the liquid crystal display in the above-described first and second embodiments, except that a data driving part which will be described later produces all the various control data otherwise generated by the controller 11 in the first embodiment or by the timing control 72 in the second embodiment, based on an enable signal supplied externally. Thereby, no part such as the above-mentioned controller 11 or the timing controller 72 is needed.

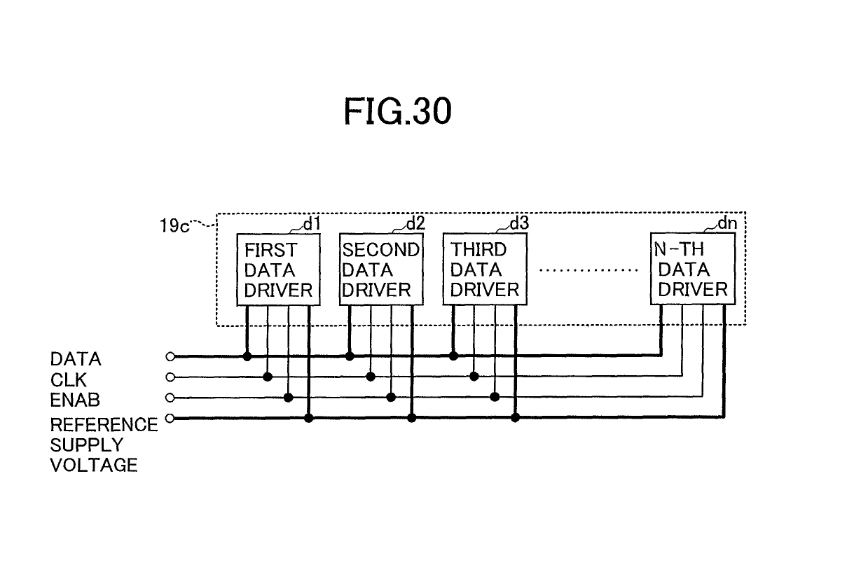

FIG. 30 is a block diagram showing a configuration of the data driving part 19c in the third embodiment of the present invention. As shown in the figure, the data driving part 19C includes a first data driver d1, a second data driver d2, a third data driver d3, . . . , an n-th data driver, connected in parallel. A data signal DATA, a clock signal CLK, the enable signal ENAB, and a reference supply voltage are supplied to each data driver from an external apparatus such as a personal computer (PC).

The enable signal ENAB is a signal for indicating a scope of data actually displayed on the liquid crystal panel from among a data signal input to the liquid crystal display. The reference supply voltage is a voltage used for generating a liquid crystal driving waveform, and is produced through level shift for driving the liquid crystal panel performed on a voltage supplied from the outside of the liquid crystal display.

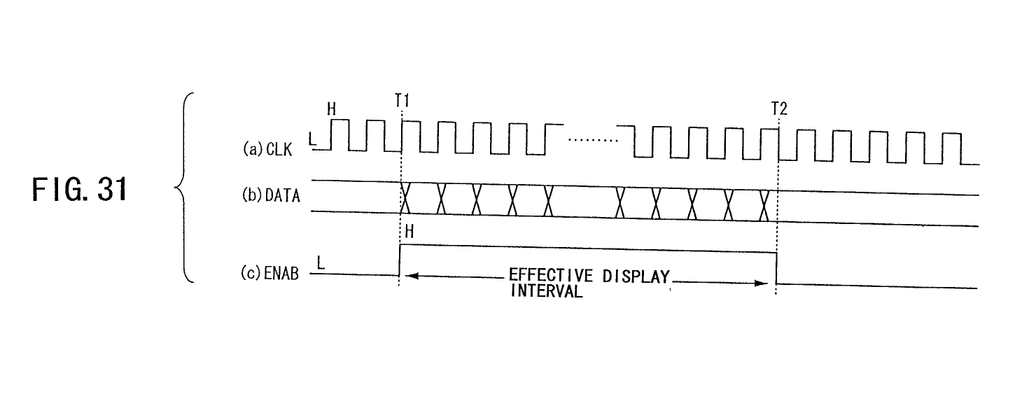

FIG. 31 is a timing chart which shows each signal supplied to the data driving part 19c shown in FIG. 30. Each data driver takes in the data signal DATA shown in FIG. 31, (b) at a timing at which the logic level of the clock signal CLK shown in FIG. 31, (a) changes from a high level (H) to a low level (L) (so-called decaying timing (decaying edge)). The phase relationship between the above-mentioned clock signal CLK and the data signal DATA is maintained constantly by the external apparatus such as the above-mentioned PC which supplies both signals.

As shown in FIG. 31, (c), the enable signal ENAB has the high level between the time T1 and the time T2, and, during this interval, the data signal DATA is actually displayed on the liquid crystal panel of the data signal DATA inputted into the display data.

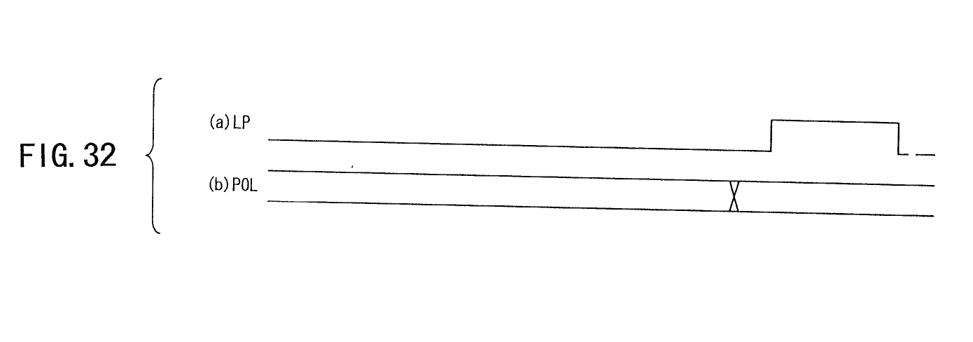

Each data driver generates a latch signal LP shown in FIG. 32, (a), and an alternate-current driving signal POL shown in FIG. 32, (b), according to the above-mentioned clock signal CLK, the data signal DATA, and the enable signal ENAB. The above-mentioned latch signal LP is a signal which controls switching at a time of transfer the data signal DATA to an outputting latch circuit for outputting the data signal DATA written in a shift register which latches the data signal DATA input into each data driver to the liquid-crystal panel. The above-mentioned alternate-current driving signal POL is signal to be supplied to a level shift circuit (not shown), in order to carry out alternate-current control of the liquid-crystal driving voltage supplied to the liquid-crystal panel.

Thereby, the clock signal CLK, the data signal DATA, and the enable signal ENAB which are supplied to the liquid crystal display from the outside can be directly supplied to each data driver as they are.

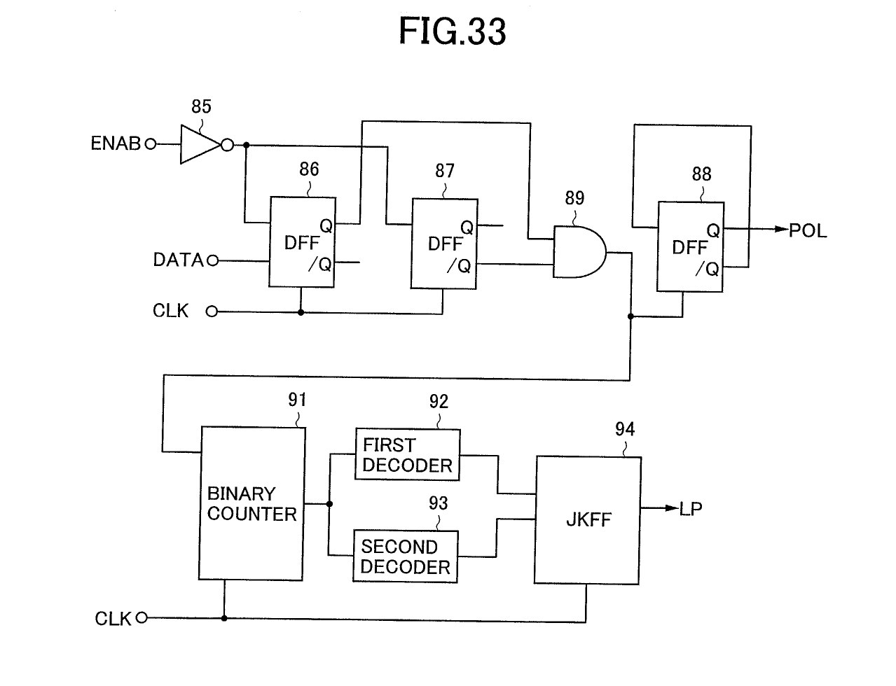

FIG. 33 shows a control signal generation circuit which is included in each data driver shown in FIG. 30, and generates the above-mentioned latch signal LP and the alternate-current driving signal POL. As shown in FIG. 33, this control signal generation circuit includes an inversion circuit 85, delay flip-flops (DFF) 86 through 88, an AND circuit 89, a binary counter 91, a first decoder 92, a second decoder 93, and a JK flip-flop (JKFF) 94.

The enable signal ENAB, the data signal DATA, and the clock signal CLK are supplied to the DFF 86, the enable signal ENAB, inverted by the inversion circuit 85, and the clock signal CLK are supplied to the DFF 87, and two input nodes of the AND circuit 89 are connected to the Q terminal of the DFF 86, and the /Q terminal of the DFF 87, respectively. The DFF 88 and the binary counter 91 are connected to the output node of the AND circuit 89. The /Q terminal and input terminal of the DFF 88 are connected together, and the alternate-current driving signal POL is outputted from the Q terminal thereof.

The clock signal CLK is supplied to the binary counter 91 and JKFF 94, both the first decoder 92 and the second decoder 93 are connected to the binary counter 91. The first decoder 92 and the second decoder 93 are connected to the JKFF 94 which outputs the latch signal LP.

The above-mentioned inversion circuit 85, DFF 86 and 87, and AND circuit 89 serve as a circuit which detects the timing (so-called decaying edge) at which the enable signal ENAB changes from a high level to a low level.

The binary counter 91 starts operation according to a signal supplied from the AND circuit 89, and supplies generated count signal to the first and the second decoder 92 and 93. The first and second decoders 92 and 93 decode the supplied count signal, and supply the thus-obtained signal to the JKFF 94.

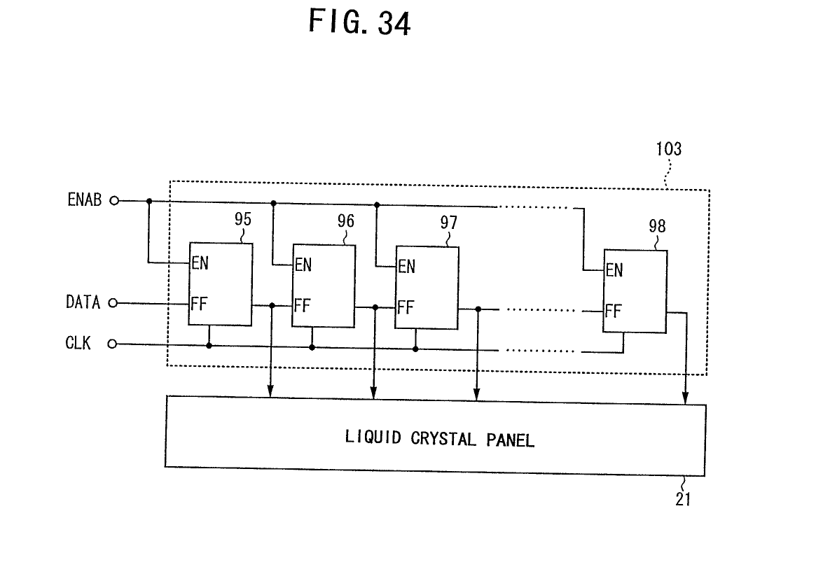

The data driving part in the third embodiment may include a driver circuit 103 shown in FIG. 34. As shown in FIG. 34, the driver circuit 103 includes flip-flops (FF) 95 through 98 connected in series. The clock signal CLK is supplied to each of the FF 95 through 98, and the enable signal ENAB is supplied to each EN terminal thereof. The data signal DATA is supplied to the FF 95.

Each of the FF 95 through 98 takes in the data signal DATA one by one when the enable signal ENAB has the high level, and the above-described driver circuit 103 supplies this data signal DATA to the liquid crystal panel 21 from the output node of each of the FF 95 through 98. Accordingly, by providing the data driving part including the above-described driver circuit 103, a data start signal to be supplied to the data driver in the liquid crystal display in the related art in order to determine data taking-in timing becomes unnecessary.

Thus, according to the liquid crystal display in the third embodiment of the present invention, the above-mentioned data start signal, the latch signal LP, and the alternate-current driving signal POL supplied to the data driver in the related art become unnecessary, and merely the enable signal ENAB should be supplied to the data driver.

Accordingly, since the controller (timing controller) which generates control signals, such as the above-mentioned data start signal, is made unnecessary through provision of the enable signal ENAB, etc., image display on the liquid crystal panel can be performed by supplying the clock signal CLK, the data signal DATA, and the enable signal ENAB to the data driving part directly from a personal computer (PC), etc., and, thereby, the liquid crystal display having a reduced circuit scale and requiring reduced costs can be provided.

By a liquid crystal display according to the present invention, since shift of the taking-in timing for image display data otherwise occurring due to a change pattern thereof can be prevented from occurring, and, thus, predetermined setup time and predetermined hold time can always be secured, and thus, reliable image display can be realized.

Moreover, since destination to which the reference voltage is supplied is switched, and, thereby, a tone-level voltage can be easily adjusted through a selecting part, and, thus, a high quality liquid crystal image can be displayed easily.

Moreover, by making equal the setup time and hold time among the plurality of data driving parts, as a result of the clock signal and image display data being made to have predetermined phase relationship without regard to the disposed position of each data driving part, reliable picture display is realizable.

Moreover, according to the present invention, since the necessity of separately providing a circuit which generates the control signal for displaying an image on the liquid crystal display part is eliminated as mentioned above, the liquid crystal display for which cost and the circuit scale can be effectively reduced can be provided.

Further, the present invention is not limited to the above-described embodiments, and variations and modifications may be made without departing from the scope of the present invention.

The present application is based on Japanese priority application No. 2000-387892, filed on Dec. 20, 2000, the entire contents of which are hereby incorporated by reference.

What is claimed is:

1. A liquid crystal display comprising:
a data driving part taking in image display data in response to a clock signal supplied, and causing an image display part to display an image according to the image display data; and
a control part detecting a change pattern of the image display data, and adjusting a phase relationship between the clock signal and image display data according to the detected change pattern.

2. The liquid crystal display as claimed in claim 1, wherein said control part uses the image display data for three clock periods of the clock signal for detecting the change pattern of the image display data.

3. The liquid crystal display as claimed in claim 1, wherein said control part delays only the image display data having a logical levels changing for each clock period of the clock signal.

4. The liquid crystal display as claimed in claim 1, wherein said control part delays the clock signal.

5. The liquid crystal display as claimed in claim 1, wherein said control part detects the frequency of the clock signal, and adjusts the phase relationship between the clock signal and image data signal according to the detected frequency as well as the detected change pattern.

6. A liquid crystal display comprising:
a data driving part having a plurality of tone-level nodes provided for tone-level voltages generated in accordance with supplied reference voltages, and causing a liquid-crystal display part to display an image according to the tone-level voltages; and
a selecting part selecting from the plurality of tone-level nodes to which the reference voltages are supplied according to a given first control signal.

7. The liquid crystal display as claimed in claim 6, wherein said selecting part is built inside of said data driving part, and the reference voltages are provided from the outside of said data driving part.

8. The liquid crystal display as claimed in claim 6, wherein said data driving part takes in a data signal transferred thereto as the reference voltage, according to a given second control signal, as the reference voltage.

9. A liquid crystal display comprising:
a plurality of data driving parts causing a liquid-crystal display part to display an image according to image display data supplied in synchronization with a clock signal;
a control part supplying the image data signal and clock signal to said plurality of data driving parts; and
a timing correcting part provided in each of said plurality of data driving parts, and making the clock signal and image display data supplied by said control part have predetermined phase relationship therebetween

10. The liquid crystal display as claimed in claim 9, wherein:
said control part detects signal transmission time periods required toward the data driving parts, generates a correction signal according to the detected data transmission time periods to be sent to said timing correcting part; and
said timing correcting part makes the clock signal and image display data have the predetermined phase relationship therebetween according to the supplied correction signal.

11. The liquid crystal display as claimed in claim 9, wherein:
said control part supplies a monitoring data signal common for the timing correcting parts; and
each of the timing correcting parts detects a phase difference between the thus-supplied monitoring data signal and the clock signal, and, thereby, make the clock signal and image display data have the predetermined phase relationship therebetween.

12. A liquid crystal display comprising:
a data driving part causing a liquid-crystal display part to display an image according to image display data by a given control signal; and
a control signal generating part built inside of said data driving part, and generating the control signal according to an external signal provided from the outside of said data driving part.

13. The liquid crystal display as claimed in claim 12, wherein said external signal comprises a clock signal for determining timing by which the image data signal is taken in by said data driving part, and an effective display signal for determining a scope of the image display data to be used for image display performed by said liquid crystal display part.

14. The liquid crystal display as claimed in claim 12, wherein said control signal comprises a latch signal for storing the image display data into a latch circuit from which the image display data is supplied to said liquid-crystal display part.

15. The liquid crystal display as claimed in claim 12, wherein said control signal comprises an alternate-current driving signal for performing alternate-current control of a liquid crystal driving voltage to be supplied to the liquid-crystal display part.

16. The liquid crystal display as claimed in claim 12, wherein said data driving part uses a voltage obtained through level shift of a voltage provided from the outside of said liquid crystal display for driving the liquid-crystal display part, and causes said liquid-crystal display part to display an image according to the image display data.

17. A liquid crystal display comprising:
a liquid-crystal display part displaying an image; and
a data driving part taking in image display data sequentially according to an effective display signal used for determining a scope of the image display data to be used for image display operation performed by said liquid-crystal display part, and causing said liquid-crystal display part to display an image according to the thus-taken-in image display data.
